(19) United States
(12) Patent Application Publication
(10) Pub. No.: US 2012/0270187 A1
(43) Pub. Date: Oct. 25, 2012

(54) FOOD CONTAINER BEHAVIOR MODIFICATION SYSTEM AND METHOD

(75) Inventor: Bruce H. MINEVITZ, Hingham, MA (US)

(73) Assignee: GOURMETRICS, Hingham, MA (US)

(21) Appl. No.: 13/455,564

(22) Filed: Apr. 25, 2012

Related U.S. Application Data
(60) Provisional application No. 61/478,702, filed on Apr. 25, 2011.

(51) Int. Cl. G09B 19/00

(52) U.S. Cl. 434/127

(57) ABSTRACT

A food container behavior modification system and method are provided. The food container behavior modification system includes a series of customized food containers including at least a first food container; a first behavior modifier integral to the first food container; a second food container; and, a second behavior modifier integral to the second food container.

### RELATED APPLICATION

The present application claims priority benefit of U.S. Patent Application Ser. No. 61/478/702, filed 25 Apr. 2011, which is incorporated fully herein by reference.

### FIELD OF THE INVENTION

Embodiments of the present invention relate generally to dietary behavior modification and, more particularly, to a behavior modification system using a series of pre-printed food containers or pre-printed materials for use with food containers for all meals during a set period of days, weeks or months, each series having unique, customized messages concerning healthy diet, weight control, and related life choices.

### BACKGROUND

The history of diet control products is filled with economic successes, but when measured by long term results, the diet control industry has regularly failed to help large numbers of people, for example overweight or obese people in attaining permanent weight loss. Globally, weight control is a growing crisis, complicating a vast number of health issues and contributing enormously to spiraling healthcare costs. Individually, weight control is a stressful and usually solitary process: it is uncomfortable to be overweight; it is emotionally challenging to undertake a disciplined, daily change in routine; and weight loss is often an activity that leaves the dieter uncomfortably out of synch with friends and family. Simply, weight control is a stressful exercise that requires, as presently configured, disciplined adherence to precise, unpleasant, and often expensive routines. The outcomes of current weight control solutions speak for their inadequacy: approximately 90% of people regain all of their lost weight within five years.

A new approach to diet control is necessary: one that overcomes the stress, negativity, isolation, and expense that accompany historic approaches, such as regimented recipe and food instructions and pre-prepared, portion controlled meals.

### SUMMARY

The embodiments of the present invention provide for an approach to dietary control that incorporates and successfully presents to each user a different set of experiences that have proven essential to successful programs of behavior modification: positivity, reassurance, variety, affordability, guidance, feedback, humor, interest, empathy, and forgiveness, to name just a few. These characteristics encourage users to practice and learn different eating and lifestyle habits that can lead to successful diet modification and sustained weight improvements. These elements are fundamental to the unique food container systems and messaging methodologies approach to diet modification or weight control presented herein.

The embodiments of the present invention relate to the creation of a series (or multiple series) of food containers coordinated with a system of varied messages presented for use at each daily meal over a number of days, weeks, or months.

An aspect of the present invention relates to integral messages on a series of food containers, that serve as integral behavior modifiers. For example, each food container is preprinted with one or more statements, diagrams, or images designed to modify behavior in respect to diet control and eating habits. The printed statements may also relate to lifestyle choices and decisions that may be causally related to weight control and self-regulation, such as sleep, stress, and exercise. The present invention provides users with a variety of relevant information in a form that is timely, helpful, informative, and encouraging.

Another aspect of the present invention is that the food containers are designed in a series for use at each of the meals during the day—generally breakfast, lunch and dinner—over a period of days, weeks, or months. An initial purchase of, or subscription to, the present invention comprises a package of multiple of food containers comprising integral (e.g., preprinted) behavior modifiers (e.g., messages) that remind and encourage the user to make sensible decisions at the specific time of eating. The preprinted messages on food containers are unique for each meal, and although there may be some repetition in theme and even specific phrasing for the purpose of behavioral reinforcement, the embodiments of the present invention anticipate variety in the multiple-times-a-day integral messages. The integral behavior modifiers may reflect conventional diet concepts such as calorie counting, low-fat diets, and portion control. The messages may also provide encouragement and exhortation: a personal coach at an affordable price every time a user prepares to eat. The system and method do not require special or prepackaged food; instead the integral behavioral messages encourage the user to make healthy choices among items they already like and prefer, and to consume these healthy items in reasonable amounts and at appropriate times.

In another aspect of the present invention, the food containers are disposable or have a limited shelf-life in order to provide the behavioral messages at the time of eating at the lowest possible price. Disposable plates are also conveniently transportable so that the behavioral message is not lost simply because a user is not eating at a fixed location. Disposable plates can be manufactured from recycled materials and/or can be recyclable.

In another aspect of the present invention, the series of food containers can be customized to match the behavioral patterns of the intended user. Most dieters undertake a weight-loss program in connection with a specific life event, e.g., a wedding, a seasonal holiday, a personal vacation, or a medical condition. The behavioral messages of the present invention are configured to provide information specifically relevant and especially encouraging in connection with the particular life event. Accordingly, for example, the length and content of a series of containers relating to an upcoming family wedding may be considerably different than the length and content of a series relating to reducing high blood pressure or cholesterol or to a healthy diet during pregnancy. Similarly, weight and diet control activities, like most efforts at significant behavior modification, result in the user experiencing a predictable cycle of emotions, e.g., enthusiasm, indifference, resistance, and acceptance. The present invention's behavioral messages anticipate these cycles and provide encouragement and feedback that validate the psychological, as well as the physical, components of weight-control and diet activities, thereby encouraging adherence to the principles expressed in the preprinted content.

In another aspect of the present invention, the series of food containers can be further personalized to provide content directly to the lifestyle patterns and the specific needs and characteristics of a particular user. The information required for personalization of the present invention can be obtained, for example, through intake questionnaires at the time of user initial subscription to the system as described herein. Because modern techniques of digital printing allow for dynamic changes in the content of a series of printed items, a series of printed food containers can also incorporate dynamic changes in content based on preset algorithms to account for the accumulated personal information of a user. At the very least, a preset series of plates can be matched to order information provided by users, for example, the food containers may display the user's name, optionally with an appropriate greeting.

Another aspect of the messaging characteristic relating to the present invention is the inclusion of a web-based system for order entry, data collection, and the provision of additional customer services. A web-based, user interface can be a scalable method for collecting data that allows for customization of the preprinted content. For example, an inbound customer can respond to a questionnaire from which a set of messages can be algorithmically generated from a larger body of content relevant to the particular user. That personalized content can then also be retained through a password-protected entry, so that a specific user can retrieve his or her personalized advice and encouragement through any personalized, internet connected device (e.g., a computer, PDA, or “smart phone”). The web portal can be available to registered users for a broader base of self-selected services, such as recipes, shopping lists, links to relevant reading and research, tools to track performance towards personal goals, and social networking. The web site may also include forums, blogs, and other advisory and counseling services to encourage collaborative behavior and reinforcement for weight control, diet and related lifestyle activities of users.

A particular computer-based embodiment provides for a “smart phone” application, or “app” that allows a user to retrieve a “virtual” food container on-demand, in instances when the physical embodiment of the food container is absent. This embodiment allows the user to receive the behavior modifying messages and, optionally, an image of the food container on the hand-held device. A related embodiment provides for an automated text message reminder, that states a behavior modifier or directs the user to the app.

In one embodiment, the present invention provides for a food container behavior modification system comprising a series of marked food containers comprising at least one behavior modifier integral and specifically designed for each food container in the series. The present invention provides users with helpful information and encouragement to guide the user through what should and should not be eaten at every meal. The embodiments of the present invention relate to a messaging platform using a series of food containers bearing integral behavior modifiers, for example printed, disposable dinner plates that encourage a participant to make sensible decisions at the time of eating. Specific embodiments provide for a series of disposable plates preprinted with different messages for each meal. The user can simply fill-up the plate and eat the food or use the behavior modifiers (e.g., diet hints) to coach the user through a meal. The series of food container (e.g., plates with integral behavior modifiers) helps the dieter control diet for specific events, like preparing for (or recovering from) holidays, for specific medical conditions, to lose weight, or simply adopt a healthier lifestyle. The system and method do not require special or prepackaged food. Rather than focusing the printed content on calorie counting, low-fat diets, or portion control—although the integral behavior modifiers may reflect these mainstream diet concepts—the present embodiments have an underlying goal of providing participants a personal “coach” every time he or she prepares to eat.

More specifically, the embodiments of the present invention provide for a series of food containers that may be for at least one day (e.g., at least two plates each corresponding to one of breakfast, lunch, dinner, or snack) or a number of days (e.g., a week, a month, several months, or a year, inclusive). The behavior modifier may be directed to a particular day (e.g., Thanksgiving day or Christmas day), a particular goal (e.g., a target weight loss), or a particular diet requirement (e.g., requirements for a low-cholesterol diet).

Another aspect of the invention provides for a method of behavior modification using a food container with at least one integral behavior modifier. The food container behavior modification method includes providing a user a series of food containers corresponding to the meals of the day, comprising at least a first food container with a first behavior modifier integral to the first food container, and a second food container with a second behavior modifier integral to the second food container. The method may further comprise providing a series of multiple food containers for the meals of multiple days.

Another aspect of the invention provides for a food container dietary behavior modification system. The food container dietary behavior modification system may include at least a first disposable plate; a first dietary behavior modifier integral to the first disposable plate; and a second disposable plate; a second dietary behavior modifier integral to the second disposable plate. Additionally, disposable plates may be provided for N number of meals and/or N number of days. The system may further comprise informational and consultative services and personalized messaging through web-connected devices and electronic messaging platforms. The combination of expert advice and encouragement from personal sources controlled by the participant makes the system especially powerful. For example, the system may further comprise an internet web site that the user may use to find information about diet, recipes, shopping lists. The web site may further allow the user to track diet compliance or weight loss. The website may also include a forum, blogs, and/or social networking activities designed to encourage user compliance with the system. The system may further comprise written materials such as a recipe book, to which the integral behavior modifier of the food container may refer.

In a particular embodiment of the invention, the first, second, and Nth dietary behavior modifiers are unique, and may each comprise a dietary portion behavior modifier, a dietary food-type behavior modifier, or a positive reinforcement behavior modifier. The dietary behavior modifiers may each be customizable to the specific dietary goal. For example, the dietary behavior modifiers may each comprise at least one of a weight-loss related dietary behavior modifier, a diabetes related dietary behavior modifier, a cholesterol related dietary behavior modifier, a pregnancy related dietary behavior, or a low-salt related dietary behavior modifier. The dietary behavior modifiers of the first, second, and Nth behavior modifier may correspond to a first meal, the second meal, and the Nth meal, respectively.

There are many unique advantages to the system and methods presented herein. The delivery of behavior modifiers through food containers is done at the moment of decision (i.e., at meal time), neither hours or days in advance nor after the fact. Information can be creatively designed and placed. The physical and virtual app-based food containers envisioned herein are light and portable, such that dieters can take their personal messages anywhere. Integral food container behavioral messages can be expressed in ways that are most appealing to the end-user, conforming to particular needs and interest, appealing to the range of moods, and offering support and encouragement throughout. Eliminating the disabling anxiety and stress of other diet approaches is a design priority, not an untoward consequence. The present invention can also be used together with other popular forms of weight control, potentiating their strengths and reinforcing tactics that a dieter has previously found effective.

### DESCRIPTION OF THE DRAWINGS

FIG. 1 is a schematic representation of a food container behavior modification system according to an embodiment of the present invention.

FIG. 2 is a schematic representation of a food container, such as the food containers of FIG. 1.

FIG. 3 is a schematic representation of a food container behavior modification method according to an embodiment of the present invention.

FIG. 4 is a schematic representation of an example internet site showing various features of an embodiment of a system for diet modification and control.

FIG. 5 to FIG. 11 are photographs of example food containers (specifically, plates) bearing integral behavior modifications related to diet and lifestyle, including food selections and alternative visual presentations.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

The present invention is not limited to the particular methodology, protocols, and expression of design elements, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. The term “or” is inclusive unless modified, for example, by “either.” For brevity and clarity, a particular quantity of an item may be described or shown while the actual quantity of the item may differ. Other than in the operating examples, or where otherwise indicated, all numbers expressing quantities of ingredients or reaction conditions used herein should be understood as modified in all instances by the term “about.” All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

The present invention provides positive guidance and encouragement for the dieting consumer. The food containers described herein provide visual eating guides that simplify portion management. The food containers contain integral behavior modifiers, such as diet suggestions, menu items and lifestyle recommendations. Each food container bears a unique behavior modifier or unique combination of behavior modifiers. These behavior modifiers exhort and encourage, using humor when appropriate, and provide psychological guidance and support and provide reminders of goals, ambitions, and timetables established by the participant. The integral behavior modifiers encourage behavioral change and provide stress management tools

Additionally, the food containers of the present invention are used at the very moment the consumer makes the eating decision. The food containers, bearing integral behavior modifiers, are a guide to behavior in real time. Creative placement of the behavior modifiers on the series of food containers keeps the process vibrant and interesting and reinforces effective habits. The system is designed to intervene at the moment of decision with simplicity and immediacy.

According to an embodiment of the present invention, a food container behavior modification system may be provided. The food container behavior modification system may include sequential food containers (e.g., disposable plates) including behavior modifiers (e.g., dietary behavior modifiers) integral to the food containers. Because the behavior modifiers may be integral to the food containers, use of the behavior modifiers may take place at a point of action (e.g., consumption). The sequential food containers may keep a particular behavior vibrant and reinforce effective behaviors with new messages. In this regard, the particular message may exhort inspirational and motivational behavior consistent with goals, discipline, and will power. Therefore, the food container behavior modification system may provide encouragement at the point of action. That is, behavior modification may be provided concurrent with meal time.

Additionally, the food containers can be taken anywhere: they are not heavy, nor are they fragile. They can also be used in conjunction with many public settings, for example in school cafeterias to fight childhood obesity or to reduce the significant personal expense of wasted food and poor food choices in buffet-style institutional settings.

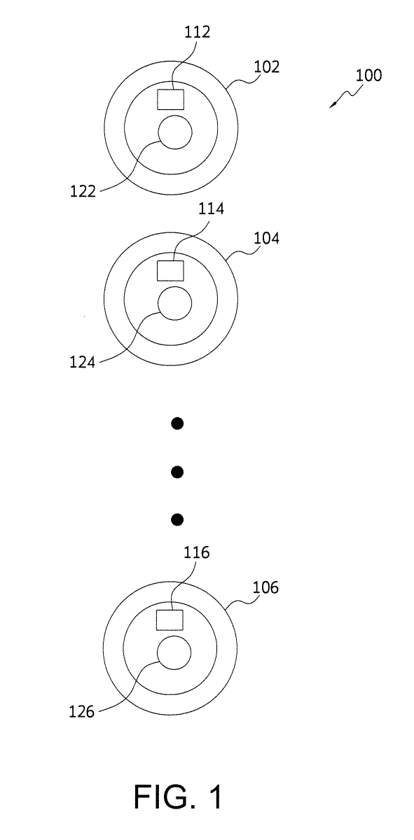

FIG. 1 is a schematic representation of a food container behavior modification system 100 according to an embodiment of the present invention. The food container behavior modification system 100 may include a first food container 102, a second food container 104, through an Nth food container 106. The first food container 102, second food container 104, and Nth food container 106 may be a plate. The size of the plate can be of standard dinner-plate size, such as 9″ to 11″ in diameter, inclusive, such as about 10¼″ or about 10¾″ in diameter. The plate or other food container, may be disposable. Although round plates are included in the embodiments shown, any appropriate food container (e.g., plate or bowl) or any appropriate shape (e.g., square, round, oval) may be included. By way of non-limiting example, bowls may be included.

The container can be made of any material suitable for production, shipment, and use. Example materials include paper, plastic, or melamine. The container may be manufactured from recycled materials. The container may be biodegradable. For example, the integral behavior modifiers and associated graphic arts can be imprinted on paper plates. In an example production of paper plates, the face of the paper plates are printed flat, in a role, using industrial scale laser to inkjet printer, then laminates as they leave the printer, then cut, then die cast into plates using heavy duty stamping machine. Commercial image screening techniques are typically employed for plastic or melamine plates, which are formed first and thus not printable by laser or inkjet printers.

The first food container 102 may include a first container identifier 112 and a first behavior modifier 122. The second food container 104 may include a second container identifier 114 and a second behavior modifier 124. The Nth food container 106 may include an Nth container identifier 116 and an Nth behavior modifier 126. The integral behavior modifier may be presented in a variety of fonts and/or colors that are pleasing to the eye, catch the reader's attention, and emphasize key points.

In a series of containers, one food container may be provided for each meal (e.g., breakfast, lunch or dinner). The first food container 102 may correspond to a first meal. The second food container 104 may correspond to a second meal. The Nth food container 106 may correspond to an Nth meal. By way of non-liming example, the first food container 102 may correspond to a first lunch, the second food container 104 may correspond to a first dinner, and the Nth food container 106 may correspond to an Nth meal. The food containers may be used in series (e.g., daily, weekly, monthly, or yearly) for particular goals (e.g., diet goals, exercise goals, snacking goals, holiday eating goals).

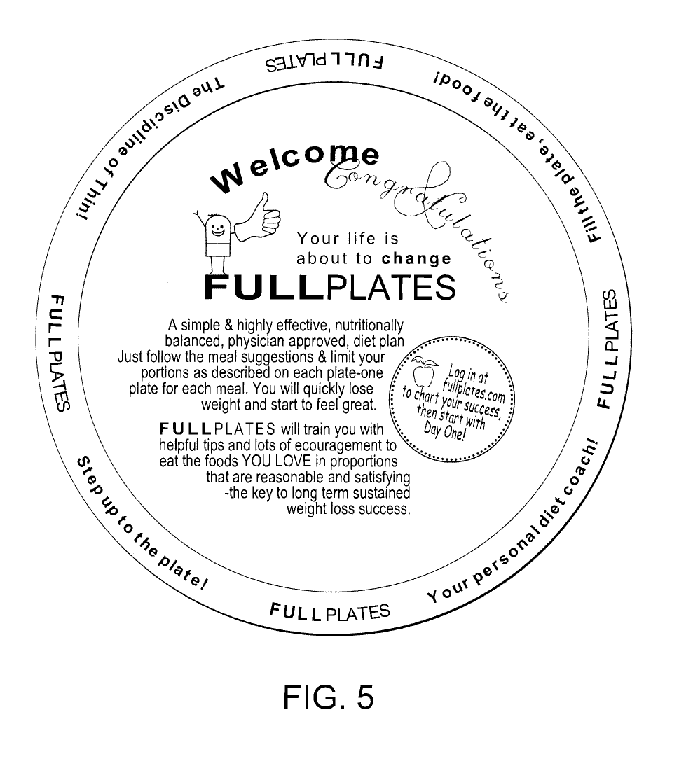

The container identifiers 112, 114, 116 may indicate the meal to which the food containers 102, 104, 106 correspond. By way of non-limiting example, the first container identifier 112 may indicate “Day One Lunch” and the second container identifier 114 may indicate “Day One Dinner.” An example “Day One Breakfast” plate is shown in FIG. 5.

The first behavior modifier 122, second behavior modifier 124, and Nth behavior modifier may include a dietary behavior modifier. The dietary behavior modifier may include a dietary portion behavior modifier. By way of non-limiting example, the dietary portion behavior modifier may indicate “3 oz. of . . . ,” “150 calories of . . . ,” “Bottle/Can of Seltzer, Water, or Diet Soda,” or “Tablespoon of Mustard, Honey, Chutney, or Jam” The dietary portion modifiers may be selected from a library of dietary portion messages that are selected individually or as cohesive meals or as meal plans for a day, such that breakfast, lunch, and dinner containers for a given day are coordinated via a computer customization engine

The dietary behavior modifier may include a dietary food-type behavior modifier. By way of non-limiting example, the dietary food-type behavior modifier may indicate “Lean White Meat Chicken or Turkey or Steak with Fat/Skin Removed” or “Mixed Fresh Salad with Katwin's Yummy Vinaigrette Dressing or Low-Fat Dressing.” The dietary food-type modifiers may be selected from a library of dietary food-type messages that are selected individually or as cohesive meals or as meal plans for a day, such that breakfast, lunch, and dinner containers for a given day are coordinated via a computer customization engine.

Additionally or alternatively to a dietary behavior modifier, the first behavior modifier 122, second behavior modifier 124, and Nth behavior modifier 126 may include other behavior modifiers. The other behavior modifiers may include an exercise behavior modifier, e.g., “Get Some Exercise Before the Big Meal Today—You Won't Feel Like it Afterwards . . . ”; a habit behavior modifier, e.g., “Keep Hydrated: If All You Had to Drink Today is Coffee, Tea and Juice, Drink 8-12 Ozs of Water with Lunch”; an attitude behavior modifier, e.g., “Holidays are Diet Nightmares—You Will Get Through This”; an activity behavior modifier, e.g., “This is a Day Where Every Place You Go . . . Cookies, Candies, Cakes and Useless Food Abound—Show Restraint and Discipline—Have a Game Plan Before You Walk Into Temptation”; or a relationship behavior modifier, e.g., “Get a Friend to Diet With You—Misery Loves Company.” Behavior modifiers can be selected to match the particular day in the series of food containers; for example “Day 7” may have messages related to “7-day itch” or “1 week down.” Table 1 presents example behavior modifiers that can be included in a computer customization engine or “style book.”

TABLE 1
Example life-style integral behavior modifiers for inclusion in message library

| | |
|---|---|
| The best things in life are not food related | This is the best way to lose weight ever! |
| The discipline of thin | No frozen meals - no food deliveries |
| Losing weight and staying thin isn't easy - | No expensive food plans - diet outside of |
| nobody said it was | the box |
| If you skip a meal, it's likely you will pig- | As you lose weight you might be tempted to |
| out the next meal - don't fall into that trap | cheat - big mistake - Do not do it |
| Fill the plate - Eat all the food | Always eat a full plate |
| It's about discipline | It's all about basic intelligent |
| | values & choices |
| Simplify your life - downsize | Make your life less food obsessed |
| Wonder what you'll do with those clothes | Preparing and controlling your own food is |
| that don't fit anymore? | healthy & cheap |
| Step up to the plate | Dieting work if you stay with it |
| Extra sauces are often full of fat | “Follow the plate to lose the weight” |
| The religion of thin | Be active today - strut your thinner body |
| To binge is to sin | It's no gimmick - It's a gradual |
| | lifestyle change |
| Sparkling or still? Just drink the water . . . | It's no joke - It's a gradual lifestyle change |
| Clothes feeling big yet? | Eat normal decent amounts of good food |
| Simple food preparations are often the best - | No meetings - private weight is between |
| you taste the food better | you and [web site] |
| Skipping meals or not cleaning your plate | If you want to lose weight, it's never a piece |
| encourages binge eating | of cake (bad joke) |
| Looking good is the best revenge | Step up to the plate |
| You need to eat like a dieter always | Don't skip meals |
| Don't be afraid to ask a restaurant to fill the | Be the designated “plater”- make sure your |
| plate - you won't be the first “plater” who | friends eat only a plateful |
| did | |
| If you go off track - get right back - all is | Wish you had started dieting sooner? It is |
| forgiven - This Once! | what it is . . . You're dieting now . . . |
| We make it easy: do what the plate says and | Compare today's lunch with what you used |
| do not cheat | to eat - isn't this great? |
| Losing weight is easier than keeping it off - | Dining out? Bring the plate - tell the chef to |
| change your eating habits and patterns | fill it up |
| Dieting works for men AND women - sort | Clean your plate so you won't cheat |
| of like toothpaste | between meals |
| Fill your day with work and activities that | Keep busy - if you are active and on the run, |
| do not include big fattening meals | there's less time to eat |
| Weigh in at the web site | Diet with your friends, it's contagious |
| Friends don't let friends eat more than | Take water and diet road mix with you |
| a plateful | |
| Bet you have saved a ton of money by now - | Side effects of losing weight - friends won't |
| junk food is expensive | recognize you |
| Bet you have saved a ton of money by now - | Coffee or tea mid-morning is OK - |
| snacks are expensive | no fat-a-chinos! |
| One plateful is a frugal person's option - | Keep well groomed - it's all part of |
| Eat frugally! | “looking good” |
| You're on a roll, although you don't eat | Keep today's plates with you to help |
| them anymore | stay focused |
| Hungry a few hours after dinner? Have a | If you look good you'll be inspired to |
| single low-cal pudding desert | maintain diet discipline |
| It's better to look forward to your next meal | Remember when breakfast meant sin |
| a little hungry than to stuff yourself all day | muffins and creamy drinks? Gross! |
| Life offers better options - embrace them! | Dieters clean their plates - eat all the food |
| Remember to always have the correct food | Today is a good day to trash unhealthy fat |
| on hand to fill the plate | foods and fat snacks |
| Don't go back to your old ways | Finish the food, go live your life |
| If your restaurant won't fill the plate, don't | Remember when breakfast meant donuts? |
| leave a tip! | Gross! |
| Hungry a few hours after dinner? Have | Remember when breakfast meant bagels |
| some fruit with a few nuts or granola | and frothy drinks? Gross! |
| Don't leave home without your plates | Being in control of what you eat is |
| | empowering! |
| You CAN control what you eat | Stick with it - Keep it up! |
| No pig-outs between meals - each plate is | You're losing weight and eating chips - how |
| more than enough | good is that?? |
| Fill ‘er up! | Being in control of what you eat is |
| | empowering! |
| Get a good night's sleep - Sleep-deprived | Save money: can't spend money while on |
| people are irritable & impatient | a treadmill |
| Exercising on a regular schedule is good | Step up to the plate |
| for you | |
| Training yourself that one plateful is enough | Simplify your life - downsize |
| Clean your plate so you won't cheat | It's about eating normal, decent amounts of |
| between meals | good food |
| Make time today for 1 hr exercise - you will | Use a shopping list so you have the right |
| feel better and lose weight faster | ingredients |
| Wonder what you'll do with those clothes | Enter your weight at the web site, keep track |
| that don't fit anymore? | of your progress |
| Spend some quality family and friends time | Keep hydrated, drink water all day long |
| You've eaten properly today - good work! | Drink water with your meal |

Table 2 presents non-limiting examples of behavior modifiers related to portion or food item or ingredient, that may be inputted into a library for search and use in a computer customization engine for customizing or producing the food containers:

TABLE 2
Example integral dietary behavior modifiers for inclusion in message library
Breakfast

| | |
|---|---|
| One (1) tablespoon of granola, or 2-3 walnuts | Small glass of grapefruit, cranberry or |
| or almonds | apple juice |
| One egg, any style OR Three (3) tablespoons of | Coffee/tea, with no-fat creamer and sugar |
| cottage cheese, PR one (1) yogurt | substitute |
| Lots of fresh fruit, especially: blueberries, | Fruit is really important, Get fresh bananas, |
| strawberries, and raspberries | apples, blueberries, raspberries, cantaloupe and |
| | watermelon. |
| Coffee or tea with the usual, which you now | Here you get a big tablespoon of cottage cheese. |
| know is sugar substitute and low fat creamer. | Can't stand it? Substitute a small low-fat yogurt, |
| Juice or OJ fine too. | or one egg any style |
| O.M.G. Bacon, turkey bacon, Canadian bacon, | 3 Options for Breakfast today: 1.) The Standard |
| vegetarian bacon (is there such a thing?) | EVERTHIN: Lots of berries, pineapple, |
| Anyway, if you want an egg or two this morning | watermelon, bananas, raspberries, strawberries, |
| (no cheese or butter) butter) you can have one | topped with a tablespoon of cottage cheese or |
| perfect piece of bacon! The less fatty the better, | yogurt OR 2.) TWO eggs any way you want - |
| but only one piece. Look at it, admire it, eat it | you can sprinkly one teaspoon only of grated |
| slowly . . . we are so good to you! Sounds | cheese if you like OR 3.) Bowl of any hot/cold |
| disgusting? Fine, substitute fresh fruit, yogurt, or | cereal with low fat milk and a tablespoon of |
| cottage cheese | maple syrup |
| 1½ pieces of toast or English muffin - whole | One slice of whole grain/whole wheat bread. |
| grain is best. A low-fat butter sprat or one | One teaspoon of buttery spray, or jelly/jam |
| teaspoon of jelly or jam is OK | |
| Because tonight is real pizza night, try to limit | One slice of toast or one small English muffin,m |
| bread this morning - let's keep it higher in | or ½ small bagel [whole grain is best] Tip: use |
| protein. So . . . 2 eggs any style - no cheese today - | on or two sprays of those lo-cal butter/olive oil |
| you'll have plenty on the pizza . . . a slice of | sprays, you will use less than trying to navigate |
| crispy bacon is OK OR Plenty of berries with 2 | a tub container - or substitute one teaspoon |
| scoops of cottage cheese. | jelly/jam |
| coffee or tea with sugar substitute and low-fat | Coffee/tea, with no-fat creamer and sugar |
| creamer or milk. A small glass of juice is OK | substitute, or just plain water |
| Today try a nice fast omelet - a couple of eggs | What are you in the mood for this nice morning? |
| (ever try just the whites?) Get it going in a fry | Select one option: Hot or cold cereal with low- |
| pan . . . add some zucchini or steamed spinach - | fat milk and fresh fruit. Two eggs with one slice |
| pinch of grated cheese - a little salt, pepper, | of crispy bacon - no cheese. Half as English |
| herbs . . . small piece of grainy bread . . . OR Hate | muffin with one slice of crispy bacon and one |
| Eggs? No Stove? Bowl of oatmeal? Bowl of | slice of cheese - all toasted. |
| Cereal? Add fresh fruit maybe a yogurt or | |
| cottage cheese for protein. Keep it simple, light. | |
| Coffee/tea as usual Very nice | Fresh fruit with a scoop of cottage cheese |
| Coffee/tea with the usual. One small fruit juice - | Coffee, tea, with no-fat creamer and sugar |
| freshly squeezed if you can. | substitute, plus a small glass of juice (orange, |
| | pinapple, apple or cranberry juice). |
| Today's breakfast is simple cereal or oatmeal. | Breakfast today Take a frozen waffle, English |
| Use low-fat milk. Add berries. You can | muffin or grainy bread. Toast it up, add an egg, |
| substitute cottage cheese for the cereal. You can | some cheese, even a single piece of crispy |
| substitute one egg any style and one piece of | bacon. |
| grainy toast with buttery low-fat spray. | |
| You can always substitute cottage cheese and | Coffee or tea, as usual. Have a small glass of |
| berries, or cereal or oatmeal. | orange, grapefruit, cranberry or apple juice. |
| Take ½ English muffin or small pice of grainy | You can always substitute a small yogurt, two |
| toast. Top it off with one egg and a slice of | spoons of granola and a small pile of fresh fruit. |
| crispy Canadian bacon. | |
| Coffee or tea, as usual. Have a small glass of | If you need more you can add a half slice of |
| orange, grapefruit, cranberry or apple juice. | American cheese - that's it. |

Lunch

| | |
|---|---|
| Let's go 60% “green” today. That means fill just | For energy, and to help you get through the day |
| over half your plate with salad and vegetables - | with no snacking, fill this section with your |
| raw is better than cooked. If you cook veggies, | selection of grilled chicken, fish, steak, ham, or |
| steam or grill them with just a little olive oil (no | pork. Lean cold cuts are OK, too. Just keep them |
| butter). You'll get used to it, just takes a little | lean - cut off the skin and fat. It's OK to brush |
| perseverence. It's OK to use two tablespoons of | on some BBQ sauce, mustard, or low-fat salad |
| low-fat salad dressing. More vinegar = fewer | dressing. |
| calories. | |
| Here you go, with rice, beans, grains, and | Fill the plate with salad and vegetables. Use two |
| legumes (whatever those are?) Seriously, you | (2) tablespoons of low-fat salad dressing. Put a |
| can substitute one piece of whole grain bread or | piece of lean chicken, turkey, cold salmon, or |
| toast, or a small whole grain or wheat roll. No | lean steak on top - or cut it into pieces for a |
| butter - but you really didn't think so. | chef's salad wannabe. No eggs, cheese or |
| | croutons! |
| Our gift: 5 baked or reduced-fat potato chips. | Our gift: 5 baked or reduced-fat potato chips |
| | or ½ piece of whole grain toast |
| The EVERTHIN Sandwich Design a) Use grain | 3 Options for lunch: Depending on how you |
| bread: wheat, multi-grain, or oat. Two slices | reacted or recovered to having a piece of bacon |
| only b) Try to use thinner slices if possible c) | this morning (even we're feeling a little guilty |
| Plain white bread doesn't work d) Lean meats, | giving you that golden nugget) select one: |
| chicken, or cold cuts work. No visible fat or skin | 1.) Big Salad with veggies and a small chunk of |
| e) One (1) slice of cheese is OK f) Sliced | chicken, turkey, lean ham or fish; 2.) The design |
| cucumbers give the EVERTHIN sandwich some | sandwich - same as yesterday, but with just one |
| crunch h) Add tomatoes, lettuce, sprouts, or any | piece of bread . . . so half a sandwich or make it |
| other veggies you like i) Key point: mustard, | “open-faced”; 3.) One cup of any non-creamy |
| salsa or chutneys are more EVERTHIN than | soup. Add two (2) small cheese/crackers as |
| mayo or butter | side |
| Eat any leftover veggies from the | Big bottle of sparkling or regular water |
| sandwich filling | |
| ADD whatever goes with your lunch selection - | Sparkling water, regular water, diet drink, iced |
| one piece of whole grain toast, OR Five (5) low- | coffee/tea . . . sugar substitutes no fat, soy |
| fat or baked potato chips, OR small cup of rice, | milk/creamer |
| grains, or more veggies | |
| GIFT: Five low-fat or baked potato chips, or | Sparkling water, regular water, diet drink, iced |
| taco chips. Five only - if you eat more, we'll | coffee/tea, sugar substitutes |
| know | |
| DRINK WATER, sparkling water, tea, or coffee | DRINK YOUR WATER, sparkling water, tea, |
| with no-fat creamer or sugar substitutes. | or coffee with no-fat creamer or sugar |
| | substitutes. |
| Easy and simple today . . . Large mixed salad - | Sandwich Day Take one piece of grainy bread - |
| low fat dressing - spray on uses less - add 4 | cut in half - lightly toasted if you want . . . 1 BLT |
| slices of any lean cold cuts or a piece of | 2 PB&J 3 mini turkey club 4 tuna 5 grilled |
| chicken/turkey (no skin) + 4 potato chips . . . | cheese (won't travel well) 6 etc. Plus 4 taco or |
| munch away! | potato chips. |
| Drink plenty of water - it fills you up - keeps the | You can always substitute a small salad with a |
| body well hydrated. | few slices of lean cold cuts |
| Add some cut up veggies - carrots, cuke, | No butter, mayo or fattening dressings. |
| celery, etc. | |
| Today's Lunch Sub-Sandwich! on the plate. You | All-in-one sandwich today. Try it open faced, |
| pick it - tuna, chicken salad, Italian cold cuts, | and use one less piece of bread. Grainy bread or |
| meatballs, buffalo chicken, etc. Six chips are | roll is best. Fill it with a combination of |
| OK, but no bread. Plenty of veggies, and just a | whatever sounds good to you. Lean cold cuts, |
| little cheese. Make it no bigger than a medium | slice of cheese, pickles, lettuce, tomatoes, |
| sub, but try for a small one. | cucumbers, artichoke, or a few olives. Use |
| | chutney or honey mustard. No mayo or creamy |
| | stuff. |
| Have sparkling water, iced tea or no-cal soda. | Need chips? Fine, have five. |
| Sparkling water, iced tea with sugar substitute, | Make your own lunch or buy a sub and proudly |
| or diet soda, etc. | dump the bread. |
| Soup and half a sandwich day Have a cup of any | |
| soup except creamy ones, such as chicken, | |
| vegetable, bean, won-ton, etc. all OK. Add ½ | |
| any small sandwich. Top with honey mustard, | |
| chutney, or jelly. | |

Dinner

| | |
|---|---|
| Any main course such as meat, fish, or chicken - | Rules: Nothing deep fried and only one |
| but it can't be cooked in butter. No cheese sauce. | reasonable serving. EverThin lets you eat what |
| We bet you know exactly what we mean. | your friends and family eat |
| Fill half your plate with a delicious salad. Use | Fill this section with rice (steamed white, long |
| different lettuces, tomatoes, and cucumbers, | grain, brown, jasmine or wild.) Hate rice? No |
| whatever combination you like - even half an | problem, have a plain mashed or baked potato. - |
| avocado. Or try your veggies grilled - squash, | small, and we mean small. A pat of butter is OK - |
| eggplant, mushrooms, onions, carrots, zucchini, | live a little! You can try mashing your potato |
| and peppers. For the salad, use two tablespoons | with some low-fat chicken broth, or use a half |
| of low-fat dressing. Steam or grill the veggies | teaspoon of sour cream. But no bacon bits, try |
| with a little olive oil. | some chives. |
| The usual salad (no cheese) or steamed/sautéed | Use now or save for the snack later. One (1) 100 |
| veggies in a little olive oil. | calorie dessert and we mean 1 Our gift |
| Our gift: 100 calorie dessert. | Tossed salad/Veggies/No Cheese/ |
| | no Croutons |
| Main Course: Whatever looks good - a piece of | To make up for the main course “free for all,” |
| chicken, fish, lean steak, lean pork chop, a | fill half your plate with salad, veggies, rice, |
| couple of meatballs - it doesn't matter. Just | grains, beans, etc. NO cheese or croutons today. |
| nothing fried, and no cheese or fat. | Low-fat dressing, two (2) tablespoons only. |
| Dinner Tonight! Truly Unexpected! Mangia! | You have to down the salad and veggies to |
| Mangia! Don't speak Italian? Then it's tuna | offset the fantastic main course. Never use |
| casserole for you. Tonight's main course is | creamy or fattening salad dressings, croutons or |
| simply terrific. Enjoy a reasonable piece of | bacon bits. Mix it up - try some avocado, hearts |
| lasagna, spaghetti and meatballs, chicken, tuna | of palm, or bok choy. Big supermarkets carry |
| casserole, fish or lean steak . . . whatever main | this stuff now. |
| course you want! | |
| One or two small pieces of bread or rolls; or a | Also, munch on a small side salad, too - any |
| small portion or potatoes or rice | dressing - limit to 2 teaspoons . . . |
| Any main course will do - try to keep the meat, | Add some assorted fresh or freshly frozen |
| chicken, or seafood as plain as possible - avoid | steamed veggies. A nice baked sweet potato - or |
| fried or ‘stuffed’ items. If you know it's not | a regular one. No sour cream, no bacon bits, no |
| perfect, like lasagna or a cheesy casserole, eat a | butter. Just a squirt of butter spray and pinch of |
| little less. One serving of just about anything - | herbs - cilantro, chives and parsley. |
| and this is a diet? | |
| Plain mashed or baked potato, or one small | One small (no cheating) baked potato - or pile |
| handful of baked plain fried - as long as you | of mashed potatoes. No fries! Or you can |
| back them in the toaseter oven or microwave | substitute a piece of whole grain toast. Low fat |
| | butter. |
| You get 2 big slices of absolutely any type of | Three (3) choices tonight: One piece of lasagna |
| pizza - with any toppings you want! Can you | (veggie if possible). One serving of spaghetti |
| believe it, can you?! It's all about pizza tonight - | and two meatballs (turkey meatballs are tasty), |
| You earned i! Don't like pizza? Ouch! OK to | or one chicken sausage. One bowl of chili. One |
| substitute a sub sandwich - even a cheesesteak- | bowl or stew with seafood with broth. |
| how good it that? OR 2 hot Dogs OR a big | |
| burger . . . yeah, really! | |
| . . . any drink you want . . . | Try a diet ginger ale with a tiny splash of |
| | cranberry juice and slice of lime - very nice |
| Drink at least 2 glasses of sparkling water or | Dessert tonight? OK One - only one - 100 |
| plain water with every meal. | calories dessert . . . ice cream cones are nice, they |
| | are tiny. |
| Chicken/turkey night. Nice piece of | BBQ Night Tonight you get ½ rack of ribs |
| chicken/turkey OK to have a little crispy skin | (really!) or a piece of chicken, or a reasonable |
| today only - gotta live a little . . . | serving of pulled pork or chicken. |
| Add a small portion of cole slaw or potato salad, | You can substitute a piece of grilled fish or six |
| and one small piece of corn bread. | grilled shrimp. |
| 50 . . . 25 . . . 50 Dinner Fill ¼ of the plate with a | Two dinner drink options - both very small. |
| great piece of steak, chicken. fish or pork - lean | Take a glass of diet ginger ale or diet grapefruit, |
| is always best - a little chutney, salsa or relish on | and add a splash of diet cranberry juice. |
| top adds a nice touch. Fill ¼ of the plate with | Decorate with a piece of lime. |
| some mashed or baked potato, rice, or even a | |
| little pasta with red sauce. Fill the remaining ½ | |
| plate with salad, or grilled/steamed veggies. use | |
| low-fat dressing or a little spray fake butter. | |

The dietary behavior modifier may include a customizable dietary food-type behavior modifier. By way of non-limiting example, the customizable dietary food-type behavior may take into account a meat versus vegetarian preference, a snacker versus non-snacker preference, and an athletic versus less physically active preference. The customizable dietary food-type behavior may be coordinated with, for example, fast-food restaurant menus, and school cafeteria menus. The food container behavior modifier may include a weight-loss related dietary behavior modifier, a diabetes related behavior modifier, a cholesterol related dietary behavior modifier, or a low-salt related dietary behavior modifier.

The behavior modifiers of the present embodiments include at least one behavior modifier in the form of positive reinforcement, such as an inspirational or coaching message that encourages the user to follow the diet. For example, a first food container may bear a positive message such as the phrase “Welcome And Congratulations: Your Life is About to Change.” Another example of a positive behavior modifier is “A Variety of Healthy Foods in Reasonable Quantities is the Key to a Healthy Lifestyle.” Further non limiting examples are shown in Table 1.

In the system of the invention, the set of food containers may include an informational pamphlet, explaining from an academic point of view the value proposition of the system. There is precedent in diet and weight control products that an information pamphlet of this kind can materially advance the public's acceptance of a new product. Additionally or alternatively, the food container may have instructions helpful in using the containers and following the diet plan. For example, an instruction may read:
A simple and highly effective nutritionally designed, physician approved diet. Simply follow the meals and limit your portions as described on each plate—one plate for each meal. You will quickly lose weight and feel great. Full Plates will train you to eat the foods you love in proportions that are reasonable and satisfying. This is the key to long-term sustained weight loss success.Log in and chart your success at the [web site identifier] Then start with Day One.

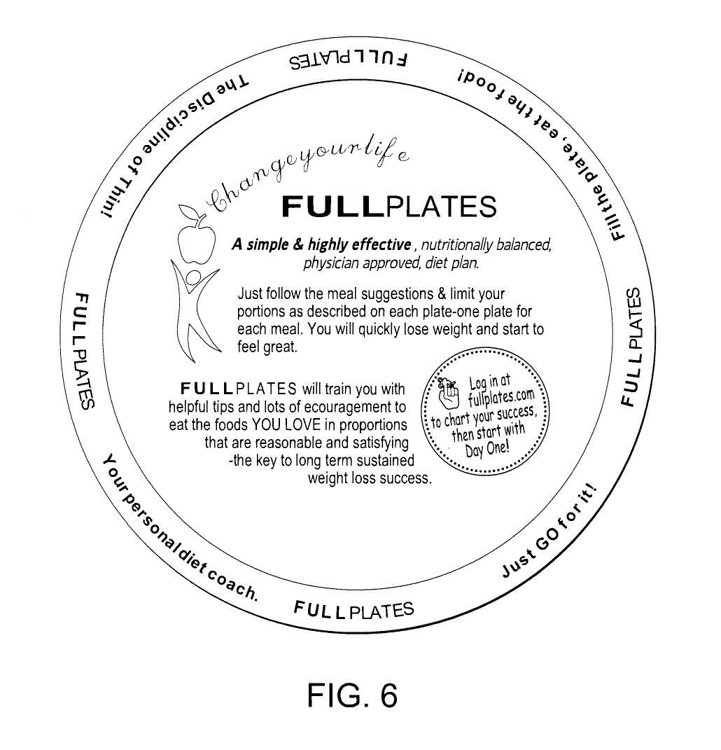

FIG. 5 and FIG. 6. show example first food containers, each bearing integral messages with the same words, but presented in alternative styles that may be chosen by, or selected for, a particular user. Note that the food container may also include an invitation for the user to incorporate the features of the web site associated with systems of the present invention. Hence, in some embodiments of the present invention, presentation features such as color, layout, animated characters, fonts, and other stylistic features may be personalized for the user.

Additionally, the behavior modifiers may be presented in a variety of visually pleasing or playful graphic arts that add to the enjoyment of meal time and foster compliance with the behavior modification program the user has selected. For example, dietary modifiers such as small desserts or small servings of potato chips may be presented within a the figure of a gift box with a ribbon.

Additionally, the system may include containers with an integral reference to books or other references useful in practicing a healthy diet, for example, “Utilize The Shopping Lists In The Book So You Will Always Have The Correct Ingredients.” Another example of an integral modifier that ties the food container to the web site is “Mixed Fresh Salad with Katwin's Yummy Vinaigrette Dressing (Recipe in Book and/or on Web Site) or Low-Fat Dressing.”

The container may also include further instruction or reminders about the use of the container, such as “Remember—One Plate Per Meal—If No Specific Portion Is Indicated, Fill-Up the Individual Section.” In an Nth plate, this instruction may be repeated more simply and use encouraging language such as “Fill 'Er Up!”

The integral modifier may also combine portion behavior modifiers and encouragement, for example, using humor, “Bonus (and you thought we have no sympathy) 4 Baked or Reduced-Fat Potato Chips.”

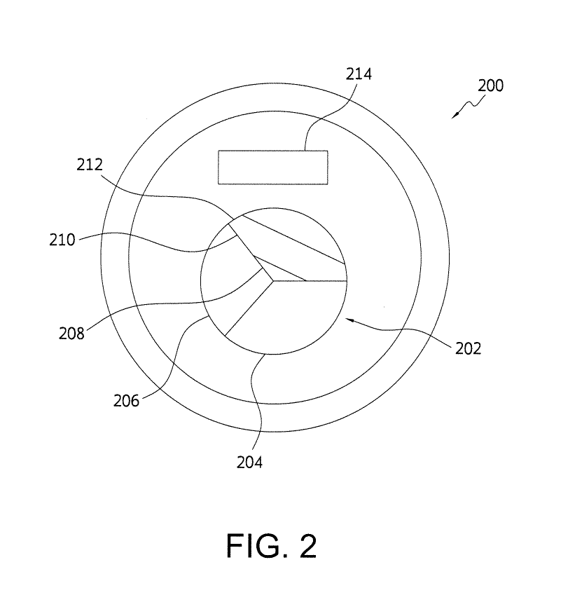

FIG. 2 is a schematic representation of a food container 200, such as the food containers 102, 104, 106 of FIG. 1. The food container 200 may include a container identifier 214 and a behavior modifier 202.

The food container 200 may correspond to a meal. By way of non-limiting example, the food container may correspond to a first lunch. The container identifier 214 may indicate the meal to which the food container 200 corresponds. By way of non-limiting example, the container identifier 214 may indicate “Day One Lunch.”

The behavior modifier 202 may include one or more portions. In the embodiment shown, the behavior modifier 202 may include five portions: a first portion 204, a second portion 206, a third portion 208, and fourth portion 210, and a fifth portion 212. Although five portions are included in the embodiment shown, any appropriate number of portions may be included. By way of non-limiting example, the behavior modifier 202 may include one portion.

As noted herein, the behavior modifier may include a dietary behavior modifier. The dietary behavior modifier may include a dietary portion behavior modifier and a dietary food-type behavior modifier. Portion control is the simplest approach to dietary weight loss, it is intuitively appealing, and it is consistent with the physiology of weight regulation. Portion control is supported by many clinical studies, and a number of companies—Weight Watchers, NutriSystems, Jenny Craig—have built their business models around the delivery of portion controlled food. These solutions for portion control can be very expensive, uncomfortably routine, and generally only work while a participant is purchasing the diet system's pre-manufactured food. In contrast, the present embodiments can emphasize the same principles of portion control while still allowing a participant the beneficial experience of picking and using their own healthy food choices at a price that is comfortable for them. By way of non-limiting examples, the first portion 204 may indicate “3 oz. of White Meat Chicken or Turkey or Steak With Fat/Skin Removed.” The second portion 206 may indicate “Mixed Fresh Salad With Low Fat Dressing.” The third portion 208 may indicate “Tablespoon of Mustard, Honey Mustard, Chutney, or Jam.” The fourth portion 210 may indicate “BONUS—Four Baked or Reduced Fat Chips.” The fifth portion 210 may indicate “One Bottle/Can of Seltzer or Water or Diet Soda.”

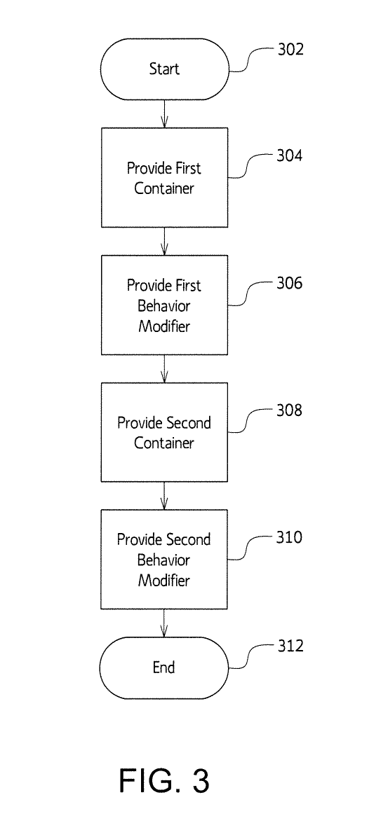

The operation of the food container behavior modification system 100 is now described with reference to FIG. 3 which is a schematic representation of a food container behavior modification method 300 according to an embodiment of the present invention.

In operation 302, the food container behavior modification method 300 may begin. In operations 304 and 306, a first food container 102 may be provided along with a first behavior modifier 122 integral to the first food container 102. In operations 304 and 306, a second food container 104 may be provided along with a second behavior modifier 124 integral to the second food container 104. Although the provision of two food containers with integral behavior modifiers are included in the embodiment shown, any appropriate number of food containers and integral behavior modifiers may be provided.

By way of non-limiting example, for a 30 day program, 90 food containers and integral behavior modifiers may be provided. A “set-day” program can include behavior modifiers coordinated with a count-down to finish, or instructions for a “weigh-in,” or similar end-point or progress indicators. See also Example 4.

The at least first and second food containers and integral behavior modifiers may be used by a user to modify the user's behavior. A use of the first food container 102 and integral first behavior modifier 122 is now described with reference to the food container 200 of FIG. 2 in the context of a dietary behavior modifier.

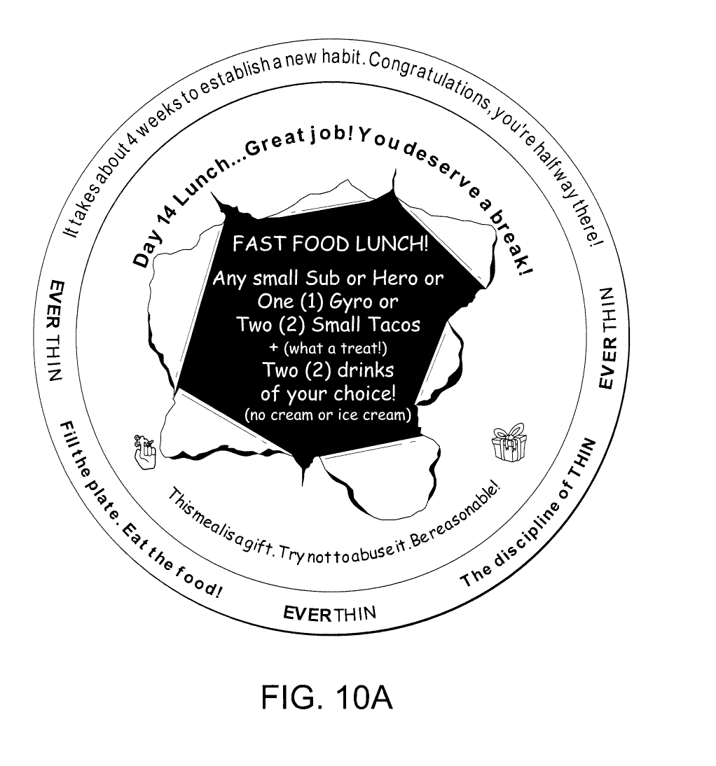

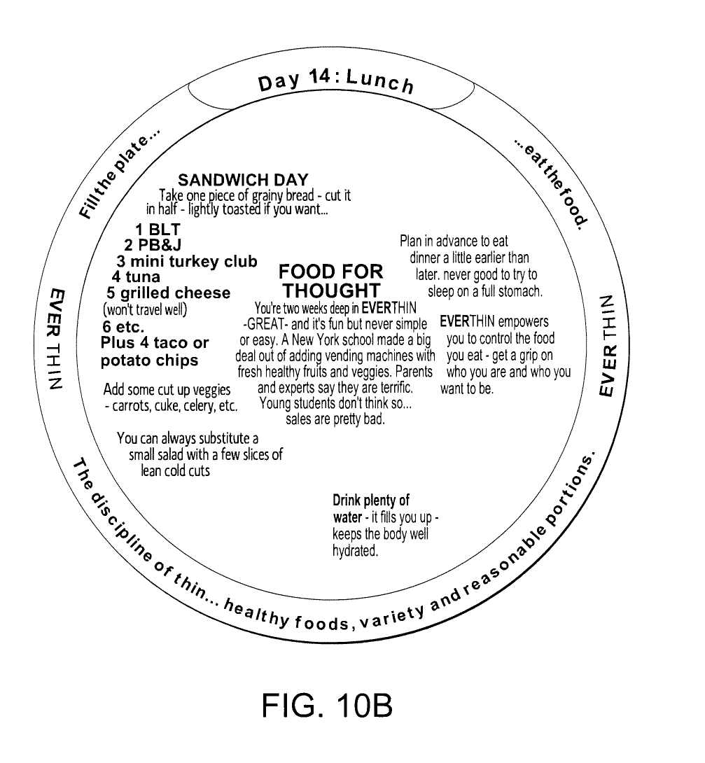

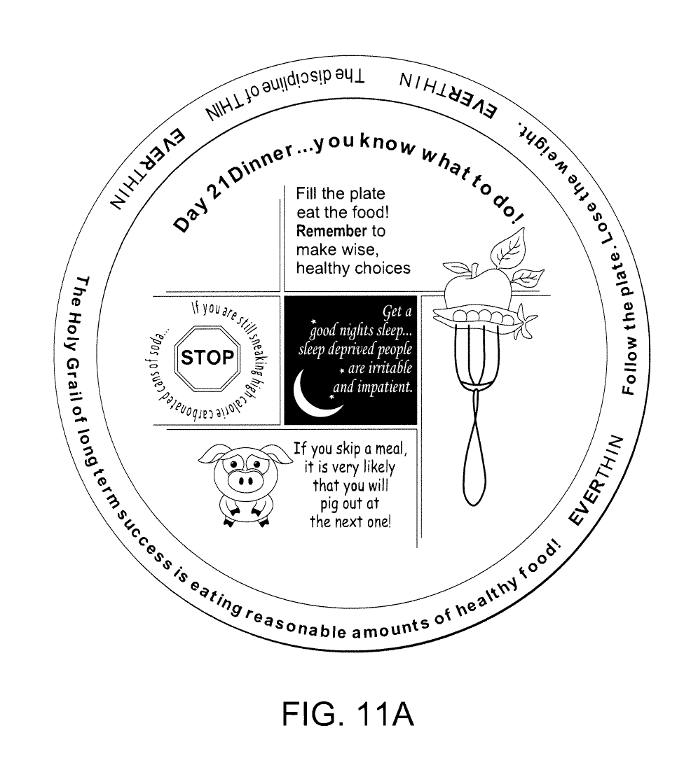

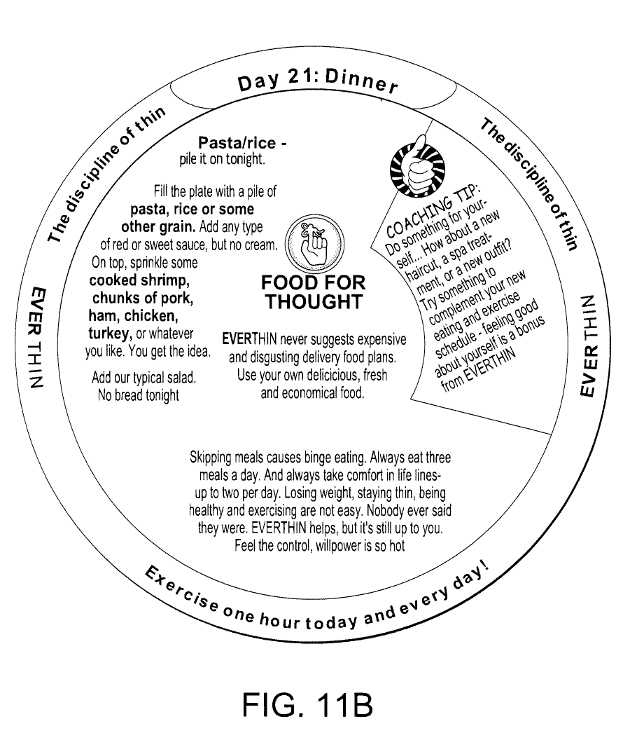

The container identifier 214 may indicate the meal to which the food container 200 corresponds and therefore may be used by the user to verify that the user has the correct food container 200. By way of non-limiting example, the container identifier 214 may indicate “Day One Lunch” and therefore may be used by the user at lunchtime on day one. See also Example 3, FIG. 5, FIG. 10 and FIG. 11

The dietary behavior modifier 202 may include first through fifth portions 204, 206, 208, 210, 212 as set forth in the non-limiting examples above. The user may consume food in accordance with the dietary behavior modifier 202 indications. By way of non-limiting example, the user may consume 3 oz. of white meat chicken, a mixed fresh salad with low fat dressing, a tablespoon of honey mustard, four baked potato chips, and a diet soda.

The system of the present invention may also include the use of internet resources. For example, interaction may include the completion of an online survey. Areas covered in the survey may include eating habits, food preferences, health conditions, special events, and any diet programs that have previously felt comfortable. Participants develop goals, and set timetables for achieving them. This data may provide a profile of a participant and can serve as the source for customized behavior modification content integral to the food containers provided for that user. Algorithmic software applications (combined with digital printing) provide easy, surprisingly intimate, yet automated, opportunities to combine profile information with pre-scripted, thematic content, thereby creating unique products for each participant.

As a result, the food containers may be customized to coordinate with other diet plans, for example, heartland, vegetarian, Mediterranean, ethnic, etc. The food container integral behavior modifiers may further take note of other medical conditions, such as heart disease, diabetes, hypertension, high cholesterol, insomnia, depression, or pregnancy. An example food container with integral behavior modifiers related to pregnancy is presented in FIG. 6A and FIG. 6B. Food containers may also may take into account dieting for special occasions (e.g., losing weight for a wedding), seasonal events, holidays (e.g., avoiding Thanksgiving Day binges), New Year's resolutions, summer clothes. Other linkages may be addressed as well, including sleep habits, smoking cessation, alcohol control, happiness, and finding partners. Special situations also may be accommodated, including travel, restaurant eaters, cafeteria eaters. Thus, the system may integrate the consumer's preferences for prepared foods as well as for home-made foods.

Web-based interactions with a customer is designed to continue with a participant's use of information and links posted on the internet site, including visual images of that meal's food container, social networking hosted and supported, online counseling, and customized prompts to consumers. Additionally, the system may include collecting data on dietary habits, successes and failures, adding value to both consumers and researchers in the area of obesity and weight control. Such data can be collected anonymously and confidentially (e.g., password-protected) and may not be limited by the complexity and expense associated with HIPAA requirements.

The system of the present invention may be used in conjunction with a web-based information network created specifically to support the use of the food containers described herein. Web design may include more traditional diet, recipe, and exercise information, as well as links to other relevant sites. The internet resource can create opportunities for online counseling and social networking. Additionally, the system can retain online versions of each user's customized messaging and establish a schedule for customized prompts to mobile devices. In this regard, the system can also be integrated into a broader weight loss program. Associated weight loss aides may be included, such as books, videos and exercise programs, one-a-day calendars. The system may also provide information or opportunities with health clubs, diet programs, restaurants, food companies, and companies marketing pharmaceuticals or medical devices for the treatment of obesity.

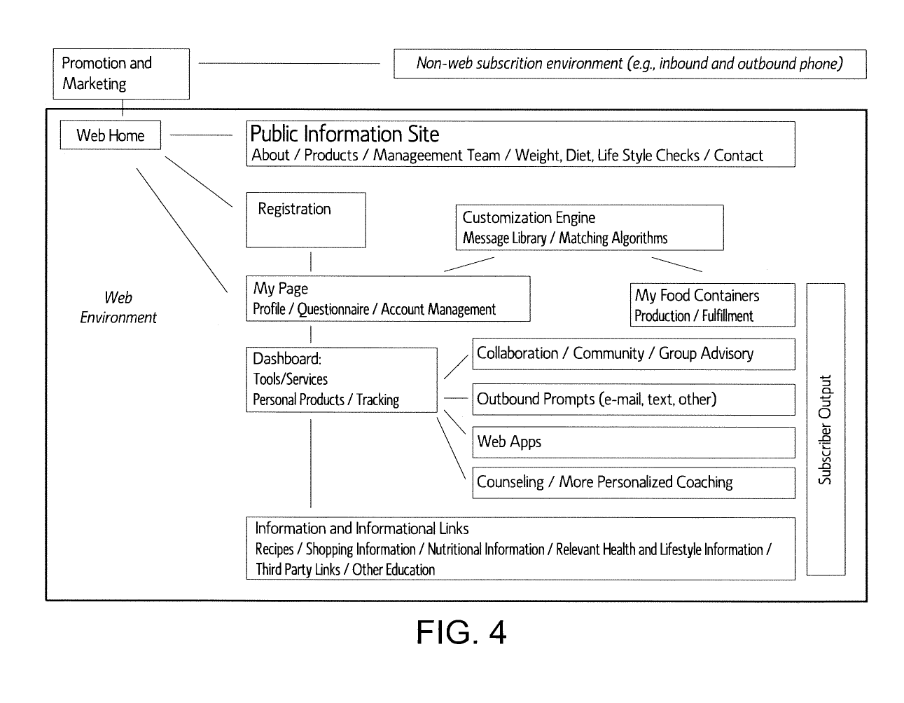

FIG. 4 presents an example web site scheme incorporating the preceding aspects in an embodiment of the system according to the present invention. The web site comprises a “Web Home” page displaying public information about the company and system, with links to pages with further details such as products, management, contact information, and information on weight, diet, and life style. The home page also links to a registration page where users can establish a personal account within the system. From the either registration page or home page, the user can navigate to their account page, “My page,” which links to account management, profile, and questionnaire features. The profile and questionnaire information is accessible by the company to provide data for the customization engine function that matches user information with a message library. More specifically, an algorithm of the customization engine matches user information with information from a “message library” such that food containers are made that include a personalized message. For example a query “Are you diabetic?” to which the answer is “yes” is matched with messages from the message library related to diabetes such that at least one message related to diabetes (e.g., management) is selected for inclusion on at least one food container for that user. These messages are retrievable via and web site as “My Food Containers” page, and are also coordinated with the hard-product supplier to appear in physical embodiments, e.g., integral on a food container in a series of containers. The web site can also link to tools and services, such as groups, emails, games or other applications, or counseling. Additionally, the home page can include links to information and nutritional information pages, third party links, and pages with shopping resources or company-owned recipes.

The system of the present invention may be combined with other therapies. Most weight control regimens, if followed, yield positive results during the period of use. Some weight loss approaches, such as surgery or drug therapies, have a greater benefit, but rarely are these solutions suitable for more than a very small percentage of the population. The present system can complement any of these and other solutions. Because the food containers are a configurable messaging platform, they can be used as an important element in a “combination” approach to weight control. Messaging may be integrated with other diet strategies to reflect a user's interests, circumstances or needs. Much as behavior-based therapies have been proven to extend the efficacy of weight loss medications, the food containers with integral behavior modifiers can provide a synergistic benefit to a wide variety of weight control programs and medical interventions.

### EXAMPLES

### Example 1

### Food Container Integral Behavior Modifiers for Thanksgiving Day

The holidays often present challenges for dieters. Particular embodiments of the present invention provide for at least one container in which the integral behavior modifiers are designed to address the holiday. As another example, for a container for use on Thanksgiving, the integral behavior modifiers may include phrases such as:
“Breakfast: It is Critical to Eat the Typical Healthy Breakfast Today. It Keeps You ‘On Point’ but, Most Importantly, it Reinforces that Today Does Not Have to be a Pathetic Pig-Out. To the Extent Possible, Treat it Like Any Other Day.”
“The Thanksgiving Plate Will Guide You Through the Meal—We Have Some Tricks & Techniques to Help You . . . ”
“Uncharacteristically, today you get a single lunch/dinner Thanksgiving plate for obvious reasons. Now, back to breakfast . . . ”
“Think About Thanksgiving as a Delicious—Single Plate—Meal.”
“Get Some Exercise Before the Big Meal Today—You Won't Feel Like it Afterwards . . . ”
“Eat a plentiful but very typical breakfast . . . it will help minimize a Thanksgiving Binge . . . it will start this dangerous eating day right!”
“Juice, lots or fresh fruit, yogurt, or a simple egg . . . No Bread . . . 1 teaspoon of granola or nuts OK, too.”
“Drink Water, Too!”
“EAT ALL THIS BREAKFAST”
“Today, We will be your Eating Psychiatrist: A plate instead of a Couch.”

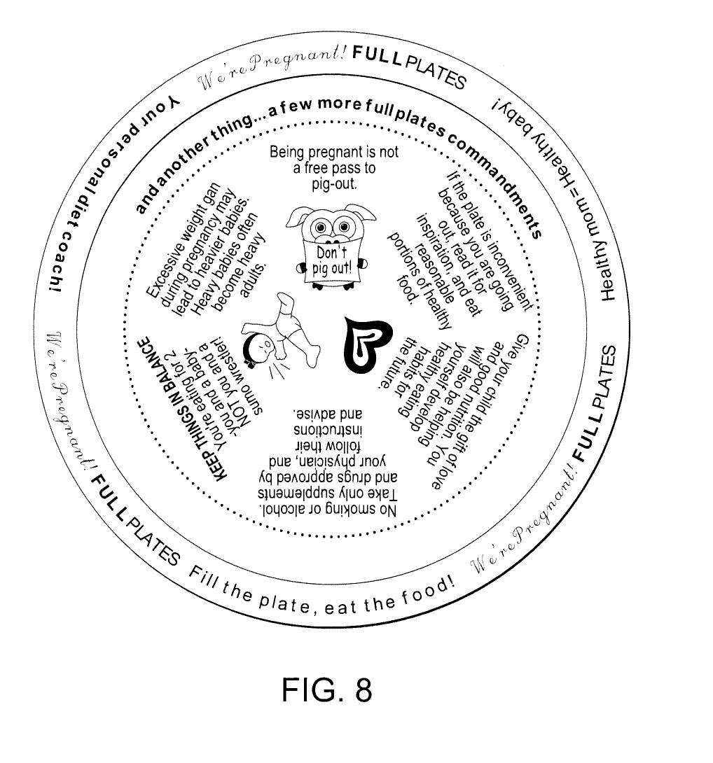

An example Thanksgiving day food container is presented in each of FIG. 8A and FIG. 8B, which include appropriate decoration to further entertain and encourage the user.

### Example 2

### Food Container Integral Behavior Modifiers for Christmas

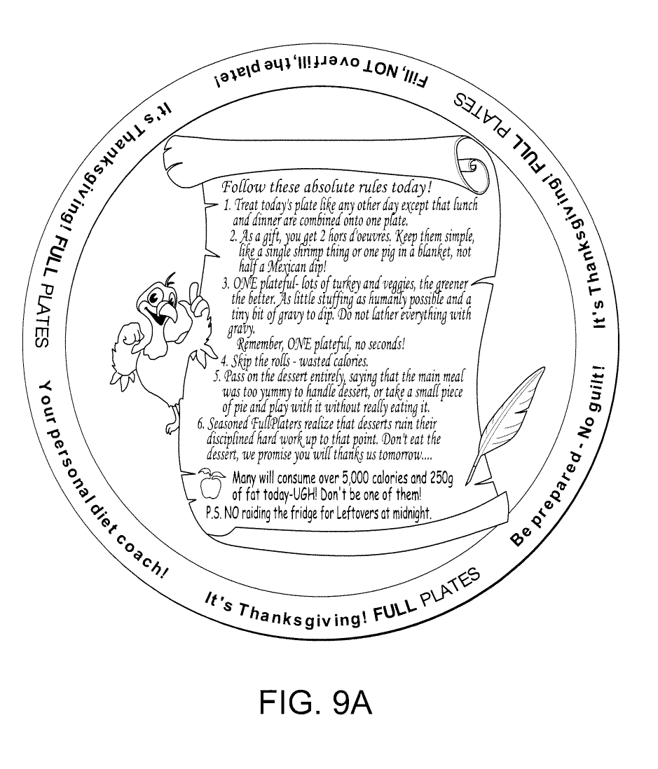

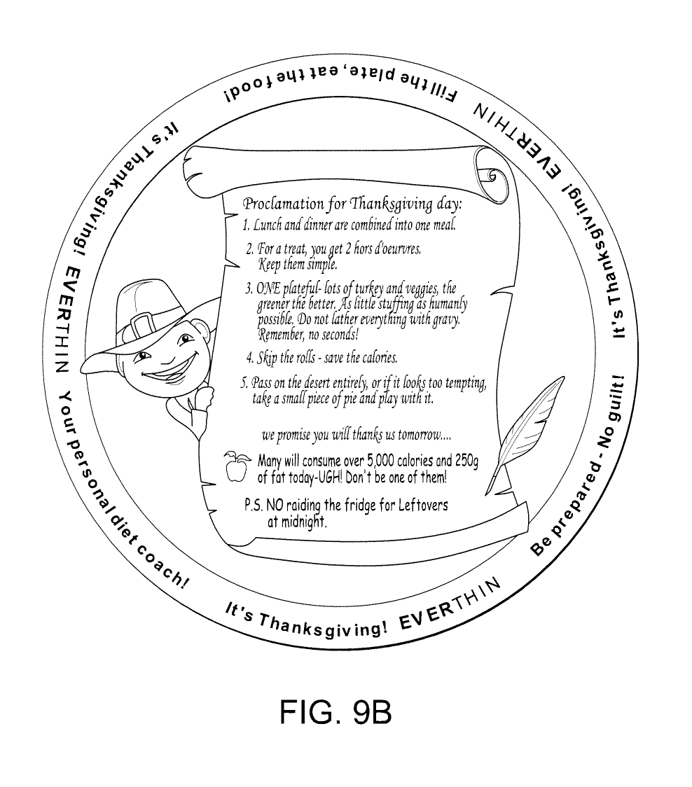

For Christmas, an example food container is shown in FIG. 9. A Christmas-specific food container may bear integral modifiers in the form of phrases such as:
“Be Mentally Prepared Today.”
“Don't be guilt-ridden tomorrow—the Mall Awaits!”
“A Day Confirming the Best Present You can give Yourself and Those who Care About You—A Thinner, Healthier and More Attractive Body.”
“Christmas Rules Absolutely (1) That today's plate like any other day except lunch and dinner are combined on a single plate; (2) Fill the plate—eat the food whether it is chicken, turkey, roast beef or goose . . . take some and fill the plate with veggies; (3) Very few potatoes, a teaspoon of gravy to dip and no rolls/bread; (4) No seconds; (5) Like Thanksgiving, pass on dessert, stating proudly ‘I filled up on the yummy main course” or take a small amount and play with it—like skinny people do—Don't Eat It; (6) The Dieter's Christmas Prayer: ‘Spritzers—Yes. Egg Nog—No. Amen’.”
“Best Christmas Return? A Return to a Thin You”
“If you are having a single Christmas meal today—you get one plate and you are done for the day—Do Not Feel Bad, Really Thin People are Eating a Lot Less than You.”
“Grazing From One Event To The Next is the Most Difficult—Plan on Your One Full Plate at the Most Logical Feeding Locale”
“This is a Day Where Every Place You Go . . . Cookies, Candies, Cakes and Useless Food Abound—Show Restraint and Discipline—Have a Game Plan Before You Walk Into Temptation.”
“Holidays are Diet Nightmares—You Will Get Through This.”

### Example 3

### Single Meal Food Container Integral Behavior Modifiers for Day 1

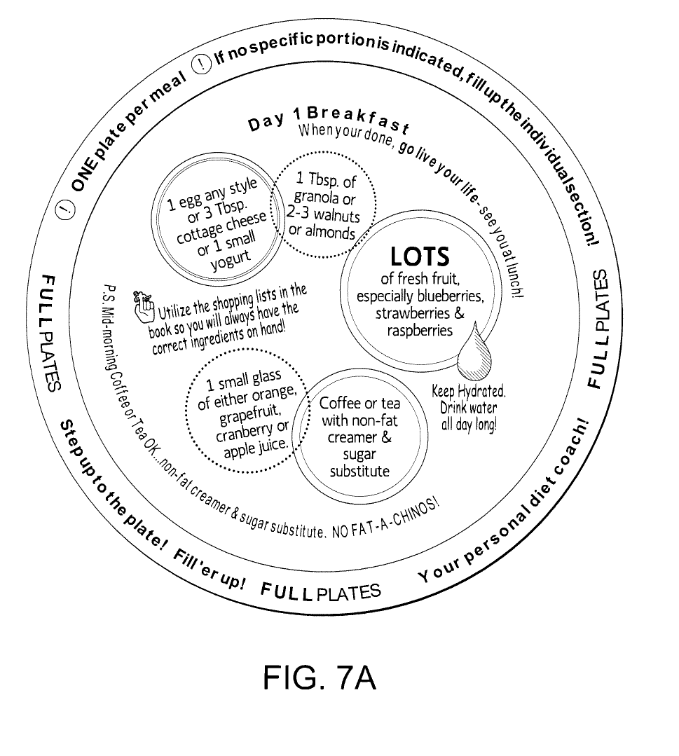

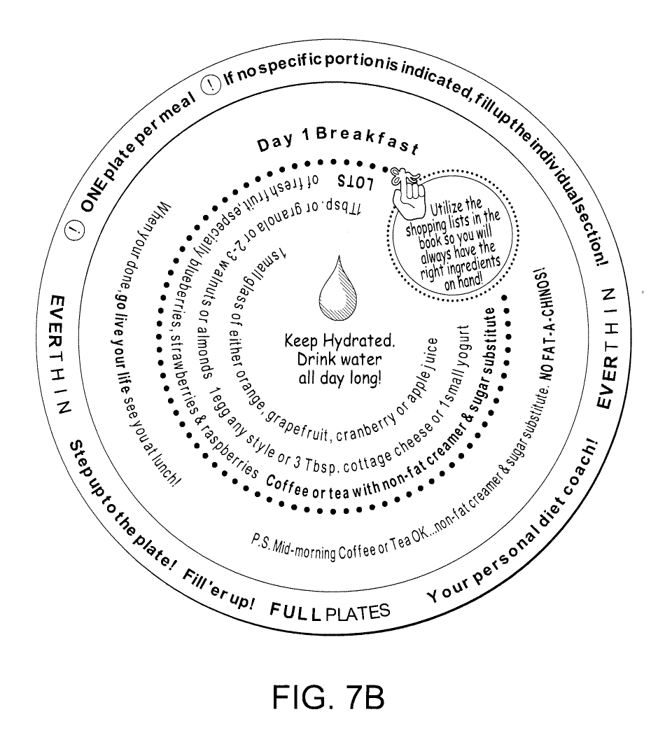

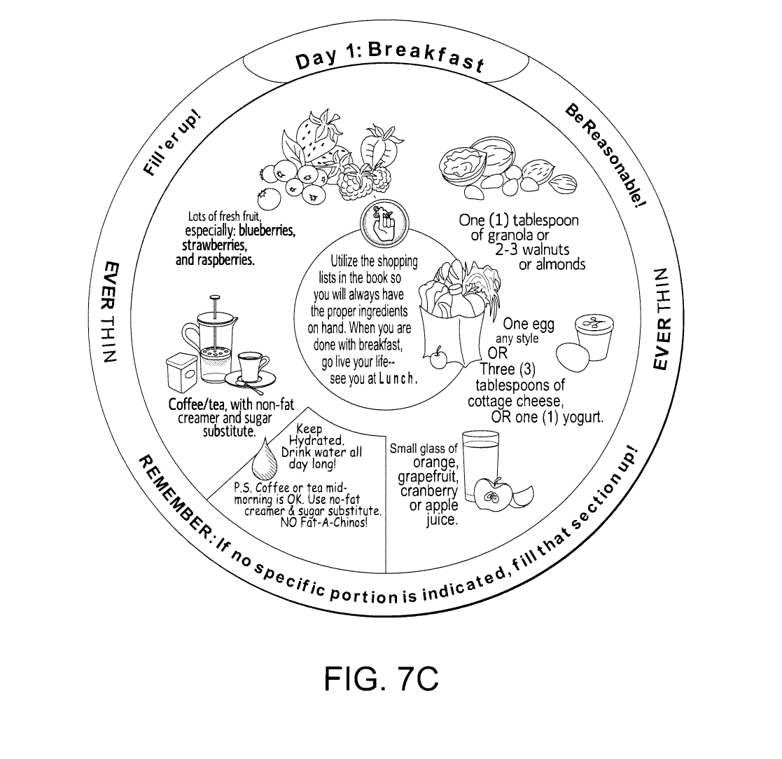

Examples of alternative embodiments for a “Day 1: Breakfast” food container with integral behavior modifiers are presented in FIG. 7-FIG. 7C.

A single food container of the present invention may contain the integral behavior modifications, arranged suitably according to the type of behavior modifier:
“Day 1 Lunch”
“Warning—Remember ONE PLATE Per Meal—if No Specific Portion is Indicated, Fill the Individual Section”
“Bottle/Can of Seltzer, Water, or Diet Soda”
“3 Oz Lean White Meat Chicken or Turkey or Steak with Fat/Skin Removed”
“Tablespoon of Mustard, Honey, Chutney, or Jam.”
“Mixed Fresh Salad with Katwin's Yummy Vinaigrette Dressing (Recipe in Book and/or on Web Site) or Low-Fat Dressing”
“Fill'er Up!”
“Bonus (and you thought we have no sympathy) 4 Baked or Reduced-Fat Potato Chips.”
“Utilize the Shopping Lists in the Book so You will Have The Right Ingredients.”
“Keep Hydrated: If All You Had to Drink Today is Coffee, Tea and Juice, Drink 8-12 Ozs of Water with Lunch.”
“Get a Friend to Diet With You—Misery Loves Company.”

### Example 4

### Series of Food Containers Consisting of 3 Containers Per Day for 30 Days

Table 3 provides an example embodiment of behavior modifiers for a 30-day series of breakfast, lunch, and dinner food containers, the behavior modifiers are integral to the series of food containers, specifically plates, customized for a weight-loss behavior. The food containers are labeled “EverThin” as an additional behavior modifier that encourages an overall and lasting life style change in relation to meals. At least one behavior modifier is included on the food container (see also Table 1) in addition to dietary behavior modifiers related to portion and/or food-type (Table 2). The behavior modifiers for a given meal of a given day can be generated by a software customization engine in response to input from a user (see FIG. 4).

TABLE 3
Integral behavior modifiers in an example 30-day series of food containers

| Day | Breakfast | Lunch | Dinner |
|---|---|---|---|
| 1 | Day 1: Breakfast. Be Reasonable. Remember: if no specific portion is indicated, fill that | | |
| | section up! Fill ‘er up! | | |
| | Lots of fresh fruit, especially: blueberries, strawberries, and raspberries. One (1) tablespoon | | |
| | of granola, or 2-3 walnuts or almonds. One egg any style, OR Three (3) tablespoons of | | |
| | cottage cheese, OR one (1) yogurt. | | |
| | Small glass of grapefruit, cranberry or apple juice. Coffee/tea, with no-fat creamer and sugar | | |
| | substitute. | | |
| | KEEP HYDRATED! Drink water all day long. P.S: Coffee or tea mid-morning is OK. Use | | |
| | no-fat creamer & sugar substitute. NO Fat-A-Chinos! | | |
| | Utilize the shopping lists in the book so you will always have the proper ingredients on hand. | | |
| | When you are done with breakfast, go live your life - see you at Lunch. | | |
| | Day 1: Lunch One plate per meal Eat your own healthy food Fill ‘er up! | | |
| | Let's go 60% “green” today. That means fill just over half your plate with salad and | | |
| | vegetables - raw is better than cooked. If you cook veggies, steam or grill them with just a | | |
| | little olive oil (no butter). You'll get used to it, just takes a little perseverence. It's OK to use | | |
| | two tablespoons of low-fat salad dressing. More vinegar = fewer calories. Here you go, with | | |
| | rice, beans, grains, and legumes (whatever those are?) Seriously, you can substitute one piece | | |
| | of whole grain bread or toast, or a small whole grain or wheat roll. No butter - but you really | | |
| | didn't think so. Our gift: 5 baked or reduced-fat potato chips. | | |
| | For energy, and to help you get through the day with no snacking, fill this section with your | | |
| | selection of grilled chicken, fish, steak, ham, or pork. Lean cold cuts are OK, too. Just keep | | |
| | them lean - cut off the skin and fat. It's OK to brush on some BBQ sauce, mustard, or low- | | |
| | fat salad dressing. | | |
| | DRINK WATER, sparkling water, tea, or coffee with no-fat creamer or sugar substitutes. | | |
| | If you skip lunch, you will just sneak an awful snack sometime this afternoon - or worse, | | |
| | you'll be so hungry at dinner you will pig out. EAT LUNCH . . . skipping meals is ILLEGAL | | |
| | on EVERTHIN! Next: If you brown bag your lunch, fill the plate at home and bring it to | | |
| | work, or put it in a big travel container. Find a way to make it work, no excuses! | | |
| | Day 1: Dinner Fill the plate . . . eat the food! The key to the discipline of THIN is all | | |
| | in moderation. | | |
| | Any main course such as meat, fish, or chicken - but it can't be cooked in butter. No cheese | | |
| | sauce. We bet you know exactly what we mean. Fill half your plate with a delicious salad. | | |
| | Use different lettuces, tomatoes, and cucumbers, whatever combination you like - even half | | |
| | an avocado. Or try your veggies grilled - squash, eggplant, mushrooms, onions, carrots, | | |
| | zucchini, and peppers. For the salad, use two tablespoons of low-fat dressing. Steam or grill | | |
| | the veggies with a little olive oil. Fill this section with rice (steamed white, long grain, | | |
| | brown, jasmine or wild.) Hate rice? No problem, have a plain mashed or baked potato. - | | |
| | small, and we mean small. A pat of butter is OK - live a little! You can try mashing your | | |
| | potato with some low-fat chicken broth, or use a half teaspoon of sour cream. But no bacon | | |
| | bits, try some chives. Our gift: 100 calorie dessert. | | |
| | COACHING TIPS: 1. Save the dessert for later when you crave a sweet. 2. For a twist, drink | | |
| | sparkling water with a wedge of lemon or lime. 3. ANY exercise helps you lose weight and | | |
| | feel better. 4. Crash dients fall over time. 90% of the weight loss is gained back in five years. | | |
| | RETRAIN yourself! | | |
| | All EverThin dinners should be prepared with foods you have or can buy economically. We | | |
| | never encourage prepared or delivered foods - yech! They are expensive and who knows | | |
| | where they came from. | | |
| | Eat slowly, dine. Don't chow down. You will begin to enjoy the pleasure of dining and | | |
| | feeling healthy. | | |
| 2 | Day 2: Breakfast Step up to the plate! Fill the plate. Eat the food. Your personal diet coach! | | |
| | Here you get a big tablespoon of cottage cheese. Can't stand it? Substitute a small low-fat | | |
| | yogurt, or one egg any style. 1½ pieces of toast or an English muffin - whole grain is best. | | |
| | A low-fat butter spray or one teaspoon of jelly or jam is OK. Fruit is really important. Get | | |
| | fresh bananas, apples, blueberries, raspberries, cantaloupe and watermelon. Coffee/tea, with | | |
| | no-fat creamer and sugar substitute, or just plain water | | |
| | SO . . . the big question is . . . did you cheat after dinner last night? You had that 100 calorie snack | | |
| | for either dessert or afterwards. If you maintained the discipline of thin, great! If not, tonight | | |
| | is another chance. By the way isn't EverThin so much better than say, a cookie diet? Can you | | |
| | believe people think you'll eat pre-packaged cookies all day? Gimmicks do not work - train | | |
| | yourself to eat three well-proportioned meals every day. | | |
| | COACHING TIPS: Look, this is plenty of food to get you to lunch. If you skip breakfast or | | |
| | do not eat all the food, you will definitely eat a bagel or Danish between breakfast and lunch - | | |
| | that's what adds on the pounds. PERSEVERE! Your body will thank you. | | |
| | Day 2: Lunch: Have you thought of exercising? You have? Great! If not, make sure it's safe | | |
| | for you, then start . . . more exercise later. | | |
| | Fill the plate with salad and vegetables. Use two (2) tablespoons of low-fat salad dressing. | | |
| | Put a piece of lean chicken, turkey, cold salmon, or lean steak on top - or cut it into pieces | | |
| | for a chef's salad wannabe. No eggs, cheese or croutons! DRINK YOUR WATER, sparkling | | |
| | water, tea, or coffee with no-fat creamer or sugar substitutes. Our gift: 5 baked or reduced-fat | | |
| | potato chips or ½ piece of whole grain toast | | |
| | NO EXCUSES You are on a business lunch - or going out to lunch with friends. Bring your | | |
| | EVERTHIN plate and use it proudly. Otherwise, read the plate, visualize the healthy, | | |
| | proportioned lunch you are supposed to have, and just order it. No fuss, no excuses. | | |
| | COACHING TIPS: Easy uncomplicated lunch today. BIG salad today. BIG sandwhich | | |
| | tomorrow. Best eating ever! This is a big lunch, it must and will get you to dinner. No | | |
| | snacking in between meals, NO CHEATING! | | |
| | Day 2: Dinner Still thinking about exercising? Stop thinking . . . START Fill the sections, no | | |
| | weighing, no counting! One plate per meal! | | |
| | Any main course will do - try to keep the meat, chicken, or seafood as plain as possible - | | |
| | avoid fried or ‘stuffed’ items. If you know it's not perfect, like lasagna or a cheesy casserole, | | |
| | eat a little less. One serving of just about anything - and this is a diet? To make up for the | | |
| | main course “free for all,” fill half your plate with salad, veggies, rice, grains, beans, etc. NO | | |
| | cheese or croutons today. Low-fat dressing, two (2) tablespoons only. One small (no | | |
| | cheating) baked potato - or pile of mashed potatoes. No fries! Or you can substitute a piece | | |
| | of whole grain toast. Low fat butter. | | |
| | Use now or save for the snack later. One (1) 100 calorie dessert and we mean 1 Our gift | | |
| | Try to make dinner a single event. Don't snack big time when you get home, then eat more | | |
| | while you are making dinner, and even more at dinner . . . not to mention those bad snacks | | |
| | between dinner and bedtime. Fill this plate, and eat it when you like. Concentrate on other | | |
| | events of life - family, friends, entertainment and (yes, there's that word again) EXERCISE! | | |
| | COACHING TIP: Eat slowly - DINE - Don't shovel, chew your food well. Give your | | |
| | stomach time to tell your brain you are eating. | | |
| 3 | Day 3: Breakfast Fill the plate, eat the food, live your life The discipline of thin. | | |
| | 3 Options for Breakfast today: 1.) The Standard EVERTHIN: Lots of berries, pineapple, | | |
| | watermelon, bananas, raspberries, strawberries, topped with a tablespoon of cottage cheese | | |
| | or yogurt OR 2.) TWO eggs any way you want - you can sprinkly one teaspoon only of | | |
| | grated cheese if you like OR 3.) Bowl of any hot/cold cereal with low fat milk and a | | |
| | tablespoon of maple syrup One slice of toast or one small English muffin,m or ½ small | | |
| | bagel [whole grain is best] Tip: use on or two sprays of those lo-cal butter/olive oil sprays, | | |
| | you will use less than trying to navigate a tub container - or substitute one teaspoon jelly/jam | | |
| | We know it's hard to make time for these full breakfasts . . . EVERTHIN knows that most | | |
| | people who skip breakfast, or just grab coffee, will chow down at 10am - eating deadly | | |
| | donuts, pastry, Danish etc. They can equal 50% of your daily calories and do nothing for | | |
| | you. Once you get used to the EVERTHIN Dinners and hopefully exercise and get a great | | |
| | night's sleep - you will wake up hungry. P.S. You get a great sandwich for lunch today! | | |
| | Day 3: Lunch Fill the plate, eat the food Attitude and discipline | | |
| | The Sandwich Design a) Use grain bread: wheat, multi-grain, or oat. Two slices only b) Try | | |
| | to use thinner slices if possible c) Plain white bread doesn't work d) Lean meats, chicken, or | | |
| | cold cuts work. No visible fat or skin e) One (1) slice of cheese is OK f) Sliced cucumbers | | |
| | give the EVERTHIN sandwich some crunch h) Add tomatoes, lettuce, sprouts, or any other | | |
| | veggies you like i) Key point: mustard, salsa or chutneys are more EVERTHIN than mayo or | | |
| | butter Eat any leftover veggies from the sandwich filling | | |
| | Sparkling water, regular water, diet drink, iced coffee/tea, sugar substitutes | | |
| | GIFT: Five low-fat or baked potato chips, or taco chips. | | |
| | Five only - if you eat more, we'll know | | |
| | Whatever, however, whyever For whatever reason you need EVERTHIN - whether you just | | |
| | let things get a little out of hand, you lost track of who you were or wanted to be, or simply | | |
| | didn't care . . . it doesn't matter . . . obviously, things are different now. | | |
| | You are on Day 3, and EverThin is working for you. So easy - so different - it so works! | | |
| | Day 3: Dinner Evenings have so many better options than eating all night. | | |
| | Get a firend to join you - it's more fun. | | |
| | Main Course: Whatever looks good - a piece of chicken, fish, lean steak, lean pork chop, a | | |
| | couple of meatballs - it doesn't matter. Just nothing fried, and no cheese or fat. The usual | | |
| | salad (no cheese) or steamed/sautéed veggies in a little olive oil. Plain mashed or baked | | |
| | potato, or one small handful of baked plain fried - as long as you back them in the toaseter | | |
| | oven or microwave | | |
| | BEWARE You had a great EVERTHIN sandwich with chips for lunch. Now for another | | |
| | excellent dinner. If you cheated between lunch and now, such as polishing off the rest of the | | |
| | chips, or eating a ton of candy, you are missing the point of three great meals per day. You | | |
| | will not meet your goal of a lifetime of being healthy, great looking, and in control of your | | |
| | diet. If you are good and can make it until breakfast tomorrow, excellent! You will wake up | | |
| | hungry and happy. But, if after dinner, or later, you just have to have a sweet, fine. Have one | | |
| | and only one of those 100 calorie desserts - they're not the greatest bu we feel your pain | | |
| | COACHING TIP: If you exercise and get into a zone, it will reduce stress - put the day's | | |
| | problems and issues out of your mind for an hour! | | |
| 4 | Day 4: Breakfast Best diet ever If your friend didn't want you to join, they will when they | | |
| | see your results | | |
| | O.M.G. Bacon, turkey bacon, Canadian bacon, vegetarian bacon (is there such a thing?) | | |
| | Anyway, if you want an egg or two this morning (no cheese or butter) butter) you can have | | |
| | one perfect piece of bacon! The less fatty the better, but only one piece. Look at it, admire it, | | |
| | eat it slowly . . . we are so good to you! Sounds disgusting? Fine, substitute fresh fruit, yogurt, | | |
| | or cottage cheese | | |
| | One slice of whole grain/whole wheat bread. One teaspoon of buttery spray, or jelly/jam | | |
| | coffee or tea with sugar substitute and low-fat creamer or milk. A small glass of juice is OK | | |
| | JUST THINKING . . . Good Morning! If you are feeling good about yourself being on | | |
| | EVERTHIN, is it due to the great food, healthy portions, variety, or easy-to-follow | | |
| | directions? or Are you feeling great about being in control and finally feeling motivated? | | |
| | Either reason is great, both are even better! | | |
| | Day 4: Lunch the discipline of thin Back to your friend who is reluctant to join you - | | |
| | remind them they are setting themselves up to be hopelessly jealous of you | | |
| | 3 Options for lunch: Depending on how you reacted or recovered to having a piece of bacon | | |
| | this morning (even we're feeling a little guilty giving you that golden nugget) select one: 1.) | | |
| | Big Salad with veggies and a small chunk of chicken, turkey, lean ham or fish; 2.) The | | |
| | design sandwich - same as yesterday, but with just one piece of bread . . . so half a sandwich or | | |
| | make it “open-faced”; 3.) One cup of any non-creamy soup. Add two (2) small | | |
| | cheese/crackers as a side. ADD whatever goes with your lunch selection - one piece of whole | | |
| | grain toast, OR Five (5) low-fat or baked potato chips, OR small cup of rice, grains, or more | | |
| | veggies | | |
| | Sparkling water, regular water, diet drink, iced coffee/tea . . . sugar substitutes no fat, soy | | |
| | milk/creamer | | |
| | FACTS 5-30% of Americans are obese and 60-70% are overweight, but it's really not their | | |
| | fault - portions are huge, fresh foods are discouraged, and our entertainment encourages | | |
| | inactivity. The fact that you are doing EverThin is a huge step - adding exercise to EverThin | | |
| | makes it even better and you'll feel great | | |
| | Day 4: Dinner Fill the plate . . . Eat the food You will diet better if friends join you. | | |
| | Dinner Tonight! Truly Unexpected! Mangia! Mangia! Don't speak Italian? Then it's tuna | | |
| | casserole for you. Tonight's main course is simply terrific. Enjoy a reasonable piece of | | |
| | lasagna, spaghetti and meatballs, chicken, tuna casserole, fish or lean steak . . . whatever main | | |
| | course you want!You have to down the salad and veggies to offset the fantastic main course. | | |
| | Never use creamy or fattening salad dressings, croutons or bacon bits. Mix it up - try some | | |
| | avocado, hearts of palm, or bok choy. Big supermarkets carry this stuff now. One or two | | |
| | small pieces of bread or rolls; or a small portion or potatoes or rice | | |
| | Rules: Nothing deep fried and only one reasonable serving. EverThin lets you eat what your | | |
| | friends and family eat Tossed salad/Veggies/No Cheese/no Croutons | | |
| | SPEED BUMP? If you're sticking to three EverThin meals a day, and trying not to cheat | | |
| | between meals seems daunting, think of this: someone in Maine lost 172 pounds in twenty | | |
| | months - but we're not making you do that! BTW, he gained the weight originally by | | |
| | “watching TV and eating everything in sight . . . ” | | |
| 5 | Day 5: Breakfast Overfill the plate . . . but never overfill your body. Eat breakfast, otherwise | | |
| | you'll cheat before lunch. Very dangerous: bagels & donuts. | | |
| | Yesterday, you had that bacon ham option . . . Mmm . . . we bet one slice never tasted so good - | | |
| | now on to eggs! When EverThin gives you that option, try to whittle it down to egg whites. | | |
| | they are loasded with protein and have less cholesterol. Add spinach or sliced zucchini, and | | |
| | even a teaspoon of grated cheese or a small slice of American cheese for a great omelet. | | |
| | Can't stand eggs? Fine, go with fruit and cottage cheese, or a bowl of cereal with fruit. | | |
| | Toasted piece of grain bread or small toasted English muffin. No Danish, donut, or sugar | | |
| | coated items. Use low fat butter spray or a dab of jelly. EverThin coffee or tea with sugar | | |
| | substitute and low-fat creamer or milk. A small glass of juice is OK. | | |
| | TWO POINTS TO CONSIDER TODAY 1) If you agonize over the little ups and downs of | | |
| | dieting, you will get discouraged. Just concentrate on EVERTHIN's healthy, controlled | | |
| | portions and you will do just fine. 2) To help your weight loss efforts, as well as to feel | | |
| | better, you must exercise regularly . . . walk, jog, run, join a gym, whatever . . . more on | | |
| | that later. | | |
| | Day 5: Lunch Step up to the plate Fill ‘er up | | |
| | Today's lunch is one small sandwich or half of a larger sandwich. Use lean turkey, ham or | | |
| | roast beef - remove all fat. Spread on honey mustard or low-fat mayo. Add lettuce and | | |
| | cucumbers. Try toasted whole grain bread. Five (5) baked/reduced fat potato or taco chips - | | |
| | you need a little crunch. Remember when you ate the whole bag? Eating a few extra crunchy | | |
| | vegetables is always the right thing to do. Have a sweet tooth? OK, one and only one mini | | |
| | candy bar (think Halloween.) Eat slowly. Do not repeat! | | |
| | EverThin is all about developing your will power - which is totally empowering - over time. | | |
| | As your life becomes more important than just eating, you will naturally spend more time on | | |
| | all the great activities of life, which will leave less time to eat . . . think about that | | |
| | Day 5: Dinner The very best things in life are not about food | | |
| | Seafood Night (Landlubber can substitute poultry) Enjoy some shrimp, scallops, or fish, | | |
| | grilled or sautéed in a little olive or canola oil. Season with herbs and a little salt and pepper, | | |
| | or citric or BBQ sauce. Never fry, cook in butter, o bread your seafood. Rice, plain potatoes | | |
| | or a small piece of bread or roll (heat it up). Low-fat buttery spray is good, dipping balsamic | | |
| | vinegar is better. Veggies - the EverThin staple, steamed or broiled with a little olive or | | |
| | canola oil. As always, if you stayed on course, have any 100 calorie treat you like - or save | | |
| | it for later tonight. | | |
| | FOOD FOR THOUGHT If your body is a machine, fill it up with high-quality fuel, but | | |
| | never overfill! Our bodies run better if just slightly underfed - we are lean and efficient. | | |
| | Pigging out makes us lazy and lethargic, like plopping on the couch after a big meal. | | |
| 6 | Day 6: Breakfast Platers do not let friends eat more than a plateful. | | |
| | This meal is a gift. Be reasonable, do not abuse it. Eat one plateful of whatever you want, but | | |
| | it must contain a full portion of fresh fruit. Only one slice of cheese, and one slice of bacon | | |
| | or ham. The holy grail of looking great long-term is eating only reasonable amounts of | | |
| | healthy, varied, quality food. Enjoy this - you're only getting a tasty salad for lunch. | | |
| | BONUS BREAKFAST DAY Life is stressful enough. Being overweight makes most people | | |
| | unhappy and adds to stress. EverThin is private and has no meetings. Keep busy - life live - | | |
| | if you are active and on the run, you will have less time to dwell on food. | | |
| | Day 6: Lunch Step up to the plate | | |
| | Not much lunch today. Fill the plate with salad, using two tablespoons of low-fat dressing. | | |
| | Add one scoop or chicken, tuna or seafood salad. Only one, not one of each. Nice try! If you | | |
| | can't stand it, add five (5) chips - you know what's allowed. Water or diet drink is best - keep | | |
| | hydrated | | |
| | Lunch Time! Hopefully, you did not go overboard with this morning's breakfast free-for-all. | | |
| | You're working hard, and having fun - on EverThin Best bet is to always make intelligent | | |
| | choices. You intuitively know the right thing to do. | | |
| | Day 6: Dinner | | |
| | Have a nice mixed up salad. We suggest two (2) tablespoons of low-fat vinaigrette dressing. | | |
| | Grilled or broiled fish, chicken, turkey, hamburger or lean steak. Put a tablespoon of BBQ, | | |
| | teriyaki, or pasta sauce on before cooking. Liven it up! Simple food preparation is best; you | | |
| | can taste the actual food! Sauces, dips and extras are seldom EverThin. A small baked or | | |
| | mashed potato, or a handful of baked fries. Ketchup is OK, Spray butter is OK. Sour cream | | |
| | or bacon bits, nope! | | |
| | Try a sparkling water or diet citrus soda with a dash of low-sugar cranberry juice. | | |
| | RESIST TEMPTATION Dinner and evening festivities offer special temptations. EverThin | | |
| | does not allow chips and dip, cheese and crakcers, or a dozen pigs-in-a-blanket before | | |
| | dinner. Don't even think about it - are you kidding? | | |
| 7 | Day 7 itch - itching to | Do not deviate from | Phrase for today: “The |
| | deviate? Don't do it - you've | the discipline. Etc. | Discipline of Thin” Etc. |
| | worked hard, it will get | | |
| | easier. Etc. | | |
| 8 | If you need a healthy snack, | Be active today Etc. | Starting to feel like this |
| | a small handful of trail mix | | might be working? Etc. |
| | will hold you over Etc. | | |
| 9 | Fill the plate - Eat the food | It's all about willpower Etc. | Be good to yourself, you are |
| | Etc. | | worth it. Etc. |
| 10 | Finish the food - Go live | Fill the plate with salad . . . | Losing weight and |
| | your life Etc. | Diet with friends Etc. | looking great! Etc. |
| 11 | Make time today for 1 hr | Are you feeling empowered | If you go off track for a |
| | exercise - you will feel better | because you've managed 11 | meal, forget it - go right back |
| | Etc. | days, and you know it's | on with a vengeance! |
| | | working? | |
| 12 | Get a life, enjoy yourself, | If your restaurant won't fill | Your body is a machine, fill |
| | you won't have time to eat so | the plate, don't leave a tip! | it with the proper fuel - |
| | much Etc. | Etc. | do not overfill Etc. |
| 13 | Breakfast | | |
| | Day 13: Breakfast The discipline of thin Eat the food - be done - go live your life - it's not | | |
| | about the food. | | |
| | Because tonight is real pizza night, try to limit bread this morning - let's keep it higher in | | |
| | protein. So . . . 2 eggs any style - no cheese today - you'll have plenty on the pizza . . . a slice of | | |
| | crispy bacon is OK OR Plenty of berries with 2 scoops of cottage cheese. | | |
| | Start thinkin abot tonight's pizz - are you doing take-out, delivery, real home made to order - | | |
| | or out to the local pizza parlor? Frozen? Only if you must . . . | | |
| | Coffee or tea with the usual, which you now know is sugar substitute and low fat creamer. | | |
| | Juice or OJ fine too. | | |
| | FOOD FOR THOUGHT Fast food is more expensive than “Real Food.” Junk foor is MORE | | |
| | expensive than healthy food. Fact - typical fast food often costs about $7.00 per person. You | | |
| | can do chicken, salad, potatoes, bread for half price . . . You just have to cook it . . . and . . . | | |
| | chips cost more than a serving of fruit or veggies. | | |
| | Day 13: Lunch Fill the plate . . . eat the food. The discipline of thin . . . healthy foods, variety | | |
| | and reasonable portions. | | |
| | Easy and simple today . . . Large mixed salad - low fat dressing - spray on uses less - add 4 | | |
| | slices of any lean cold cuts or a piece of chicken/turkey (no skin) + 4 potato chips . . . | | |
| | munch away! | | |
| | Big bottle of sparkling or regular water | | |
| | No expensive food plans . . . no nasty pre-prepared delivered food. Think outside the box. | | |
| | Go get some exercise today - make sure you have good footwear - then exercise. It's all part | | |
| | of the EverThin. Baths, showers, steam sauna all feel so good after exercise. | | |
| | FOOD FOR THOUGHT If more people are overweight than thin, sometimes it's tough to | | |
| | figure out jst how much weight we should lose - after all, being overweight just seems | | |
| | normal. That is just a pathetic rationale. Do not fall for that! | | |
| | Day 13 Dinner Fill the plate . . . eat the food. No gimmicks - EverThin is economical because | | |
| | you eat healthy food. This meal is a gift and a test - can you eat a limited amount? You used | | |
| | to binge on this kind of food - no longer - skinny people eat this food - only not much - and | | |
| | not often. | | |
| | You get 2 big slices of absolutely any type of pizza - with any toppings you want! Also, | | |
| | munch on a small side salad, too - any dressing - limit to 2 teaspoons . . . any drink you want . . . | | |
| | Can you believe it, can you?! | | |
| | It's all about pizza tonight - Day 13 - You earned i! Don't like pizza? Ouch! OK to substitute | | |
| | a sub sandwich - even a cheesesteak - how good it that? OR 2 hot Dogs OR a big burger . . . | | |
| | yeah, really! | | |
| | FOOD FOR THOUGHT A key to long term weight loss success is understanding that you | | |
| | just have to enjoy this kind of meal/splurge one in a while - after you've earned it. Eat slowly | | |
| | because tomorrow we are right back on track. | | |
| 14 | Day 14: Breakfast The discipline of thin Eat the food - be done - go live your life - it's not | | |
| | about the food. | | |
| | Today try a nice fast omlet - a couple of eggs (ever try just the whites?) Get it going in a fry | | |
| | pan . . . add some zucchini or steamd spinach - pinch of grated cheese - a little salt, pepper, | | |
| | herbs . . . small piece of grainy bread . . . OR Hate Eggs? No Stove? Bowl of oatmeal? Bowl of | | |
| | Cerial? Add fresh fruit maybe a yogurt or cottage cheese for protein. Keep it simple, light. | | |
| | Coffee/tea as usual Very nice | | |
| | EverThin is about eating normal, decent amounts of good food . . . As you get used to eating | | |
| | this way, you'll become unable to pig-out. Your body will not tolerate it - congrats!! | | |
| | FOOD FOR THOUGH You have got to exercise - it makes losing weight easier and it's | | |
| | good for you. But getting you to tart a regular, daily exercise routine is not easy. A new | | |
| | England medical school tried to encourage people to exercise by walking their dogs. One | | |
| | lazy participant said that their dog doesn't want to walk - go figure. | | |
| | Day 14: Lunch Fill the plate . . . eat the food The discipline of thin . . . healthy foods, variety | | |
| | and reasonable portions. | | |
| | Sandwich Day Take one piece of grainy bread - cut in half - lightly toasted if you want . . . | | |
| | 1 BLT 2 PB&J 3 mini turkey club 4 tuna 5 grilled cheese (won't travel well) 6 etc. Plus 4 | | |
| | taco or potato chips. | | |
| | Add some cut up veggies - carrots, cuke, celery, etc. | | |
| | You can always substitute a small salad with a few slices of lean cold cuts | | |
| | Drink plenty of water - it fills you up - keeps the body well hydrated. | | |
| | Plan in advance to eat dinner a little earlier than later. Never good to try to sleep on a full | | |
| | stomach. EverThin empowers you to control the food you eat - get a grip on who you are and | | |
| | who you want to be. | | |
| | FOOD FOR THOUGHT You're two weeks deep in EverThin - GREAT - and it's fun but | | |
| | never simple or easy. A New York school made a big deal out of adding vending machines | | |
| | with fresh healthy fruits and veggies. Parents and experts say they are terrific. Young | | |
| | students don't think so . . . sales are pretty bad. | | |
| | Day 14: Dinner No gimmicks - EverThin is economical because you eat healthy food. Fill | | |
| | the plate . . . eat the food. Today is the 2 week mark - well done! | | |
| | Chicken/turkey night. After last night's pizza, try some comfort food. Nice piece of | | |
| | chicken/turkey OK to have a little crispy skin today only - gotta live a little . . . | | |
| | Add some assorted fresh or freshly frozen steamed veggies. A nice baked sweet potato - or a | | |
| | regular one. No sour cream, no bacon bits, no butter. Just a squirt of butter spray and pinch | | |
| | of herbs - cilantro, chives and parsley. Dessert tonight? OK One - only one - 100 calories | | |
| | dessert . . . ice cream cones are nice, they are tiny. | | |
| | Drink at least 2 glasses of sparkling water or plain water with every meal. | | |
| | Remember: When selecting foods and lifestyle choices, lots of fruits and veggins whole | | |
| | grains are great. Keep salt minimized. Fish is a good choice. Only lean meats. Keep sugar | | |
| | down - never drink sugary drinks. Lots of water! Only 3 meals a day. | | |
| | FOOD FOR THOUGHT It's really not our fault to need EverThin to guide us. Things get off | | |
| | to a tough start - a recent government survey showed that 12-19 year olds failed miserably | | |
| | meeting expected diet standards. Their regular exercise habits were pathetic. Also, make up | | |
| | for lost time - now. | | |
| 15 | Day 15: Breakfast The discipline of thin Eat the food - be done - go live your life - it's not | | |
| | about the food | | |
| | What are you in the mood for this nice morning? Select one option: Hot or cold cereal with | | |
| | low-fat milk and fresh fruit. Two eggs with one slice of crispy bacon - no cheese. Half as | | |
| | English muffin with one slice of crispy bacon and one slice of cheese - all toasted. | | |
| | Fresh fruit with a scoop of cottage cheese | | |
| | Coffee/tea with the usual. One small fruit juice - freshly squeezed if you can. | | |
| | One hour of decent exercise. Figure out NOW how you are going to work it into your day. | | |
| | No excuses! | | |
| | Lots of bread, bagels, French toast and pancakes are simply the wrong way to start your day. | | |
| | We do not allow it. Some people have a few donuts or danishes, and two fat-a-chinos to start | | |
| | their day. We all known what they look and feel like. | | |
| | FOOD FOR THOUGHT EverThin isn't the big convenience foods because their nutritional | | |
| | values are poor. Get used to simple and fresh foods. It's easy to design healthy selections, | | |
| | even when you're you - bt even then, restaurant and take-out portions are huge. Think | | |
| | EverThin at every meal - see the results. | | |
| | Day 15: Lunch Fill the plate . . . eat the food. Remember, one full hour of exercise today - | | |
| | keep track! | | |
| | Soup and half a sandwich day Have a cup of any soup except creamy ones, such as chicken, | | |
| | vegetable, bean, won-ton, etc. all OK. Add ½ any small sandwich. Top with honey mustard, | | |
| | chutney, or jelly. No butter, mayo or fattening dressings. | | |
| | Buy something for yourself today. You have EverThinned for over two weeks! Reward | | |
| | yourself - if it's clothing, it will fit better - so far you're doing great! | | |
| | Want pizza to be a vegetable? Eat vegetables and think about pizza. | | |
| | FOOD FOR THOUGHT The Department of Agriculture and the food industry recently | | |
| | tangled on whether tomato paste on pizza can count as a vegetable fo school lunches. The | | |
| | food industry won the argument. Don't try it here - EverThin says pizza is NOT a vegetable. | | |
| | Are you kidding? | | |
| | Day 15: Dinner Lunch Fill the plate . . . eat the food. No gimmicks - EverThin is economical | | |
| | because you eat healthy food Three (3) choices tonight: One piece of lasagna (veggie if | | |
| | possible). One serving of spaghetti and two meatballs (turkey meatballs are tasty), or one | | |
| | chicken sausage. One bowl of chili. One bowl or stew with seafood with broth. You | | |
| | promised to do one hour of exercise today - decide now. Before or after dinner? We like it | | |
| | before, it will make you nice and hungry for dinner. | | |
| | If you are a little stressed from work, or if family and friends are driving you crazy, then take | | |
| | 30 minutes and relax alone . . . take a long bath, shower or sauna - or meditate. | | |
| | Think nice thoughts. | | |
| | The best vacation is 30 minutes alone in your own world - there are endless options. | | |
| | FOOD FOR THOUGHT Trust your gut. EverThin guides you though three healthy, well- | | |
| | proportioned meals every day, while leaving much of the food selection to you. You know | | |
| | instrinctively that a tasty broiled fish is better than a fried fisherman's platter loaded with | | |
| | tartar sauce. We treat you like an adult - trust your gut! | | |
| 16 | Think about doing something | On half of any sandwich on | Add exercise, sleep and low |
| | special for yourself. Etc. | whole grain bread and a | stress, and you are good to |
| | | small salad. Etc. | go. Etc. |
| 17 | SAVE THE CRAVE We all | DANGER ZONE The time | THINK ABOUT IT Skipping |
| | crave salt or sweets from | between breakfast and lunch | meals or not eating three full |
| | time to time. Regular healthy | is a minefield of deadly | meals a day cases binge |
| | meaks and exercise are the | eating and cheating | eating or snacking. Etc. |
| | only things that work. Etc. | opportunities. Don't mess up. | |
| | | Etc. | |
| 18 | COACHING TIP: It is just | Very Cool Idea: Make any | FOOD FOR THOUGHT: To |
| | fine to wake up a little | sandwich you feel like - tuna, | be clear, EverThin is |
| | hungry. It means you did not | chicken, club, BLT, steak, | counting on you to be |
| | pig out last night and your | cheese, THEN, toss out the | physically active, if it is safe |
| | body is craving healthy, | bread or roll before you eat | for you to do so, for at least |
| | beneficial food. It feels good | it. Gift: Scoop this mess uip | one hour per day. It doesn't |
| | to be a little hungry - the | with a maximum of four low- | matter when you squeeze it |
| | food tastes better. Feeling | fat chips, taco chips or | in, just get it done. You must |
| | stuffed is miserable, | grainy crackers. | do it for long-term success - |
| | unhealthy and gross. | | no excuses! |
| 19 | Because EverThin pushes | COACHING TIP: Have your | Anything Tonight Be |
| | three meals per day with | life lines ready if you are | reasonable, Here are the |
| | little or no snacking in | starving before dinner or | Rules: Any meal at all, we |
| | between, there will e times | exercise - did you remember | don't care, we're not |
| | when you just want to snack. | to exercise? | watching and we won't tell. |
| | So, we feel your pain - every | Etc. | Just a plateful. But it must be |
| | day you can cheat up to two | | proportioned - that means |
| | servings of these life lines. | | some main course, some |
| | Etc. | | vegetables, salad, and some |
| | | | grains, pasta or potato. Etc. |
| 20 | FOOD FOR THOUGHT | Try it without mayo today. | Hate red meat? Substitute |
| | Grocery chains are | Take something that you | broiled salmon, chicken, or |
| | expanding nutritional | normally slather with a | pork tenderloin. |
| | labeling with data, color | gallon of mayo - like tuna, | COACHING TIP: Get you |
| | codes, tags and circles. | chicken salad - and mix it up | one hour of exercise in |
| | Really bad foods are seldom | with a healthy alternative. | before you eat dinner tonight. |
| | singled out. Less than 33% | Try low-fat balsamic, honey | it's a nice full meal which |
| | of all people claim to really | mustard, chutney, or even | you should savor and linger |
| | understand it all and only 7% | just a little fancy jelly or jam. | over. You might not feel like |
| | use it all the time. This is a | Get off the mayo thing! Etc. | exercising afterwards. Etc. |
| | simple and terrific | | |
| | alternative. | | |
| 21 | Try a couple of frozen | COACHING TIP: By | Pasta/rice - pile it on tonight. |
| | waffles - whole grain is best - | concentrating on small | Fill the plate with a pile of - |
| | drizzle a teaspoon of honey | delicious portions, you can | pasta, rice or some other |
| | or maple syrup on top. Add | eat almost anything once in | grain. Add any type of red or |
| | cooked egg or a tablespoon | a while. Etc. | sweet sauce, but no cream. |
| | of cottage cheese. Etc. | | Etc. |
| 22 | NOT US! Recent studies | Change up your cultural | A Simple Prediction No |
| | confirm that over ⅓ of the | comfort zone. - as part of the | matter how good it used to |
| | U.S. adult population are not | new thinner you, if you only | feel to satisfy exhaustion, |
| | just overweight, but actually | watch movies, try a book - if | stress, over-work, |
| | obese, having a body mass of | you wear only conservative | disappointment, or possible |
| | more than 30. Not to worry, | clothes, but something | low self-esteem with tons of |
| | not us - NO WAY! Etc. | different - buy a pair of | bad foods, it will feel |
| | | boots - works for men and | so much better when you have |
| | | women. Etc. | lost weight and look terrific. |
| | | | Etc. |
| 23 | COACHING TIP: Here's | If you get home for the | You've been in EverThin for |
| | another lifeline option. Eight | evening and immediately feel | over three weeks and it's |
| | nuts - have walnuts, | the urge for a bag of chips, | going really well because |
| | almonds, whatever. Eat them | have a lifeline ready and | you're not counting calories. |
| | slowly, they're good for you | waiting. Then, go live your | You're eating your own fresh |
| | as long as you eat just a few. | life, dinner will be there | food, and not wasting time |
| | Etc. | when you want it. | with diet gurus. |
| 24 | Introduce your body to | Lunch today is with or | Fill the Plate. Eat the food. |
| | something new and healthy. | without a piece of grainy | Lose the weight! Etc. |
| | Etc. | toast or whole grain role. Etc. | |
| 25 | Drink plenty of water. Bottle | Schedule your one hour of | The discipline of thin. We |
| | or tap. Etc. | exercise - NOW no excuse! | are not in this alone. Etc. |
| | | Etc. | |
| 26 | We are approaching 30 days - | The discipline of thin Your | Life is Simple. Fill the Plate. |
| | Stage 1 of EverThin. Etc. | Conscience - Your Guide | Eat the Food. Live Life. Etc. |
| | | Etc. | |

| | |
|---|---|
| 27 | Day 27: Breakfast The discipline of thin Your Conscience - Your Guide |
| | Today's breakfast is simple cereal or oatmeal. Use low-fat milk. Add berries. You can |
| | substitute cottage cheese for the cereal. You can substitute one egg any style and one piece of |
| | grainy toast with buttery low-fat spray. |
| | Coffee, tea, with no-fat creamer and sugar substitute, plus a small glass of juice (orange, |
| | pinapple, apple or cranberry juice). |
| | Remember - be sure to exercise one hour every day for these last five days. Weigh in |
| | at Day 30. |
| | COACHING TIP: If EverThin is working for you, get another thirty day set and keep on |
| | the discipline. |
| | Day 27: Lunch Your Conscience Your Guide Eat Slowly - think about the food - Do |
| | Not Shovel! |
| | All-in-one sandwich today. Try it open faced, and use one less piece of bread. Grainy bread |
| | or roll is best. Fill it with a combination of whatever sounds good to you. Lean cold cuts, |
| | slice of cheese, pickles, lettuce, tomatoes, cucumbers, artichoke, or a few olives. Use chutney |
| | or honey mustard. No mayo or creamy stuff. |
| | Need chips? Fine, have five. |
| | Have sparkling water, iced tea or no-cal soda. |
| | Weigh-in soon - one hour of exercise today. |
| | COACHING TIP: These are satisfying, good meals. Eating all three every day is the key. |
| | Lifeline snacks are fine in between meals. Pig-outs, obviously not. |
| | Day 27: Dinner Life is simple. Fill the plate. Eat the Food. Live Life. |
| | BBQ Night Tonight you get ½ rack of ribs (really!) or a piece of chicken, or a reasonable |
| | serving of pulled pork or chicken. |
| | Add a small portion of cole slaw or potato salad, and one small piece of corn bread. |
| | You can substitute a piece of grilled fish or six grilled shrimp. |
| | Have one small scoop of ice cream or flavored ice. No pecan pie, sorry . . . |
| | One hour of exercise today! |
| | Exercise has its benefits. We all know it burns calories, keeps us healthy, and makes us feel |
| | upbeat and pumped. Now scientists think it even helps to speed up “autophagy,” the process |
| | of our cells cleaning out and disposing of their “debris.” You wouldn't want constipated |
| | cells, would you? |
| | COACHING TIP: Remember, one plate, one portion. That is the key. Regular food, normal |
| | portions - they might seem small, but you;ll get used to it. It's the price of long term weight |
| | loss - keeping it off - and eating the foods you love. |
| 28 | Day 28: Breakfast The discipline of thin Your Conscience Your Guide |
| | Breakfast today Take a frozen waffle, English muffin or grainy bread. Toast it up, add an |
| | egg, some cheese, even a single piece of crispy bacon. |
| | You can always substitute cottage cheese and berries, or cereal or oatmeal. |
| | Coffee or tea, as usual. Have a small glass of orange, grapefruit, cranberry or apple juice. |
| | Weigh-in will be in three days. Exercise and stay on point. |
| | Eating slowly . . . do it like the monks. Buddhist monks sometimes treat eating like |
| | meditation. They eat slowly, think about the food - its taste, texture, color and satisfaction. If |
| | you can't be bothered, at least eat at half speed. Plowing it down can't be good. |
| | COACHING TIP: The point of eating a real breakfast is to help you avoid all the bagels, |
| | danishes, muffins, triple fat-a-chinos, and boxes of donuts we used to eat - |
| | all recipes for disaster! |
| | Day 28 Lunch Your Conscience Your Guide Eat Slowly - think about the food - |
| | Do Not Shovel! |
| | Today's Lunch Sub-Sandwich! on the plate. You pick it - tuna, chicken salad, Italian cold |
| | cuts, meatballs, buffalo chicken, etc. Plenty of veggies, and just a little cheese. Six chips are |
| | OK, but no bread. Make it no bigger than a medium sub, but try for a small one. |
| | Make your own lunch or buy a sub and proudly dump the bread. |
| | Sparkling water, iced tea with sugar substitute, or diet soda, etc. |
| | Two more days to go. Don't forget, if this is working, line up another 30 day set. |
| | GUITLY CONSCIENCE By now you should be feeling guilty on any day you do not get |
| | your exercise in. You should always be able to squeeze the hour in - while watching TV, |
| | before you jump in the shower, when you first wake up . . . schedule a time in your head every |
| | day and simply do it. The health and weight benefits are huge . . . |
| | COACHING TIP: We feel like having a little sweet today. Two mini, mini candy bars (nano |
| | bars). Better eat these bad boys slowly or they'll be gone before you know it. |
| | Day 28 Dinner Life is Simple. Fill the plate. Eat the Food. Live Life. Your Conscience Your |
| | Guide |
| | 50 . . . 25 . . . 50 Dinner Fill ¼ of the plate with a great piece of steak, chicken. fish or pork - |
| | lean is always best - a little chutney, salsa or relish on top adds a nice touch. Fill ¼ of the |
| | plate with some mashed or baked potato, rice, or even a little pasta with red sauce. Fill the |
| | remaining ½ plate with salad, or grilled/steamed veggies. use low-fat dressing or a little |
| | spray fake butter. |
| | Two dinner drink options - both very small. Take a glass of diet ginger ale or diet grapefruit, |
| | and add a splash of diet cranberry juice. Decorate with a piece of lime. |
| | Practice What You Preach: recent studies show that overweight doctors are less likely to |
| | discuss weight issues with their overweight patients. Question - would you trust an |
| | overweight doctor to advise you on weight issues or would you prefer a fit doctor? |
| | COACHING TIP: If you do a full hour of exercise today, have a 100 calorie dessert - |
| | bribery so works! |
| 29 | Day 29 Breakfast The discipline of thin Your Conscience Your Guide |
| | Try Canadian bacon instead of regular bacon - it has fewer calories. |
| | Take ½ English muffin or small piece of grainy toast. Top it off with one egg and a slice of |
| | crispy Canadian bacon. If you need more you can add a half slice of American cheese - |
| | that's it. |
| | You can always substitute a small yogurt, two spoons of granola and a small |
| | pile of fresh fruit. |
| | Coffee or tea, as usual. Have a small glass of orange, grapefruit, cranberry or apple juice. |
| | Yet another reason to stay thin: Pro athletes who are overweight have all kinds of issues with |
| | ankle, knee and hip injuries. Physicians often realize that overweight patients are at greater |
| | risk during surgery. Seems like the world is against being overweight. Don't fight it, diet. |
| | COACHING TIP: You crave - we're good with it - in small portions only. |
| | Day 29: Lunch Your Conscience Your Guide Eat Slowly - think about the food - |
| | Do Not Shovel! |
| | Chef's Salad Today's lunch is chopped lettuce, tomoato, cucumber, etc. Add one clice of |
| | ham, turkey, shicken or roast beef - cut it up. Add one slice of cheese, cut it up. Toss the |
| | whole thing with two tablespoons of low-fat dessing. Eat with five chips - that's it! Sparkling |
| | water, diet iced tea, diet soda, or plain water. Hydrate by drinking plenty of liquids. One hour |
| | of exercise today. Do it when you can. |
| | FOOD FOR THOUGHT Over 200,000 Americans have expensive and invasive weight-loss |
| | surgery every year. sometimes they work, sometimes they don't. If EverThin sin't working |
| | for you, you're cheating when we're not watching. Weigh-In tomorrow, we shall see! |
| | COACHING TIP: Line up another 30-dat EverThin set . . . This has to be working for you! |
| | Day 29 Dinner Eat the Food. Live Life. Life is Simple. Fill the Plate. |
| | 1/4 plate baked potato or small mound of pasta with red sauce. Use to squirts of buttery spray |
| | on the potato. 1/4 plate steamed or roasted veggies - or saute them in a bit of olive oil. ¼ |
| | plate empty. What? Just seeing if you are paying attention. That's plenty of dinner anyway, |
| | and you're getting dessert. |
| | Try a diet ginger ale with a tiny splash of cranberry juice and slice of lime - very nice |
| | Have a tiny mini nano dessert today? A small, small candy bar, or a mini cupcake, or a 100 |
| | calorie ice cream. |
| | Think About It: The world supersizes - we undersize. Isn't it better to undersize than to get |
| | huge and have to eat practically nothing to lose the weight? Embrace diet - way better. |
| | Weigh-in day 30 is tomorrow! Can't wait . . . |
| | COACHING TIP: When you're up for another 30 days of EverThin, get a friend to do it with |
| | you - it's easier, and you get extra support - or continue on your own and make your friends |
| | jealous. It's your choice, you know who you are. |
| 30 | Day 30: Breakfast Losing Weight - Better Some Than Perfect Weigh In Today Celebrate |
| | Breakfast options today. (A) Single egg - single piece of crispy bacon, juice, coffee/tea (as |
| | usual) (B) Fresh fruit, cottage cheese, juice coffee, tea (as usual) (C) Cereal or oatmeal with |
| | fresh fruit, juice, coffee, teas (as usual). Booster trick for weigh-in day: Skip the bread today. |
| | If this is working for you, re-up for another 30 days. We'll keep you on track. |
| | Recipe for Disaster: you made it to Day 30 - you will feel a natural tendency to let up, |
| | celebrate, pig out, let down your guard. Be VERY careful . . . Go easy! Gaining back weight |
| | is way easier than losing it - you've worked too hard - |
| | Day 30 Lunch Weigh In Today Losing Weight - Better Some Than Perfect |
| | Lunch options today (A) Mixed salad with a little grated cheese and some chopped up ham, |
| | chicken, turkey, etc. Low-fat dressing. Very few crackers, chips (B) sandwich on grainy |
| | bread - no mayo - honey mustard OK, Lean cold cuts/1 slice of cheese . . . Add cup of soup - |
| | not creamy. |
| | Get a haricut. Take a walk outside. Buy new shoes. Buy nre underwear. Start a new book. |
| | Feel Confident. Feel good about yourself. |
| | Buy some new clothes today - not a whole wardrobe - you have more to go . . . |
| | Day 30: Dinner Weigh In Today Losing Weight . . . Better Some Than Perfect |
| | Dinner Tonight Try to go out to dinner and celebrate. Show your will power (A) Salad first |
| | (B) Basic steak/chicken/fish/seafood (C) More veggies than potatoes (D) Dessert - anything - |
| | eat only half. |
| | As we continue for another 30 days, remember that moderate weight loss, over time, is the |
| | best way because it's sustainable - fast weight loss is simply gained back. |
| | Your weigh in number this is the most you will ever weigh forever: it's a nice |
| | thought isn't it |
| | WEIGH IN Write the number in a couple of places you can see and can't miss - such as |
| | your bathroom mirror, cell phone, computer screen. Your weight today is the highest for the |
| | rest of your life - keep working at it |

Although embodiments of the present invention have been shown and described, it would be appreciated by those skilled in the art that changes may be made in these embodiments without departing from the principles and spirit of the invention, the scope of which is defined in the claims and their equivalents.

1. A food container behavior modification system, comprising:
a first food container;
a first behavior modifier integral to the first food container;
a second food container; and
a second behavior modifier integral to the second food container.

2. The food container behavior modification system of claim 1, wherein at least one of the first behavior modifier and second behavior modifier comprise a dietary behavior modifier.

3. The food container behavior modification system of claim 2, wherein the dietary behavior modifier comprises a dietary portion behavior modifier.

4. The food container behavior modification system of claim 2, wherein the dietary behavior modifier comprises a dietary food-type behavior modifier.

5. The food container behavior modification system of claim 2, wherein the dietary behavior modifier comprises a customizable dietary food-type behavior modifier.

6. The food container behavior modification system of claim 2, wherein the dietary behavior modifier comprises at least one of a weight-loss related dietary behavior modifier, a diabetes related dietary behavior modifier, a cholesterol related dietary behavior modifier, a low-salt related dietary behavior modifier, or a pregnancy related dietary behavior modifier.

7. The food container behavior modification system of claim 2, wherein the first behavior modifier comprises a first dietary behavior modifier and the second behavior modifier comprises a second dietary behavior modifier, and wherein the first dietary behavior modifier corresponds to a first meal and the second dietary behavior modifier corresponds to a second meal.

8. The food container behavior modification system of claim 1, wherein at least one of the first behavior modifier and second behavior modifier comprise at least one of an exercise behavior modifier, a habit behavior modifier, an attitude behavior modifier, an activity behavior modifier, and a relationship behavior modifier.

9. The food container behavior modification system of claim 1, wherein at least one of the first food container and second food container comprise a plate.

10. The food container behavior modification system 9, wherein the plate is disposable.

11. A food container behavior modification method, comprising:
providing a first food container;
providing a first behavior modifier integral to the first food container;
providing a second food container; and
providing a second behavior modifier integral to the second food container.

12. The food container behavior modification method of claim 11, wherein at least one of the first behavior modifier and second behavior modifier comprise a dietary behavior modifier.

13. The food container behavior modification method of claim 12, wherein the dietary behavior modifier comprises a dietary portion behavior modifier.

14. The food container behavior modification method of claim 12, wherein the dietary behavior modifier comprises a dietary food-type behavior modifier.

15. The food container behavior modification method of claim 12, wherein the dietary behavior modifier comprises a customizable dietary food-type behavior modifier.

16. The food container behavior modification method of claim 12, wherein the dietary behavior modifier comprises at least one of a weight-loss related dietary behavior modifier, a diabetes related dietary behavior modifier, a cholesterol related dietary behavior modifier, and a low-salt related dietary behavior modifier.

17. The food container behavior modification method of claim 12, wherein the first behavior modifier comprises a first dietary behavior modifier and the second behavior modifier comprises a second dietary behavior modifier, and wherein the first dietary behavior modifier corresponds to a first meal and the second dietary behavior modifier corresponds to a second meal.

18. The food container behavior modification method of claim 11, wherein at least one of the first behavior modifier and second behavior modifier comprise at least one of an exercise behavior modifier, a habit behavior modifier, an attitude behavior modifier, an activity behavior modifier, and a relationship behavior modifier.

19. The food container behavior modification method of claim 11, wherein at least one of the first food container and the second food container comprise a plate.

20. The food container behavior modification method of claim 19, wherein the plate is disposable.

21. A food container dietary behavior modification system, comprising:
a first disposable plate comprising a first dietary behavior modifier integral to the first disposable plate;
a second disposable plate comprising a second dietary behavior modifier integral to the second disposable plate,
wherein the first dietary behavior modifier and the second dietary behavior modifier each comprise a dietary portion behavior modifier and a dietary food-type behavior modifier,
wherein the first dietary behavior modifier and the second dietary behavior modifier are each customizable,
wherein the first dietary behavior modifier and the second dietary behavior modifier each comprise at least one of a weight-loss related dietary behavior modifier, a diabetes related dietary behavior modifier, a cholesterol related dietary behavior modifier, and a low-salt related dietary behavior modifier, and
wherein the first dietary behavior modifier corresponds to a first meal and the second dietary behavior modifier corresponds to a second meal.

22. The food container dietary behavior modification system of claim 21, wherein said modifiers are customized using data obtained from user interaction with an internet-based software application.

23. The food container dietary behavior modification system of claim 22, wherein said user interaction consists of profile and questionnaire data input into a message library engine.
